(19) United States
(12) Patent Application Publication
(10) Pub. No.: US 2023/0236521 A1
(43) Pub. Date: Jul. 27, 2023

(54) METHOD FOR MANUFACTURING RESIN PARTICLE DISPERSION FOR TONER

(71) Applicant: KAO CORPORATION, Tokyo (JP)

(72) Inventors: Sumihiro SUZUKI, Wakayama-shi (JP); Takayuki KIBATA, Wakayama-shi (JP); Tsuyoshi ODA, Wakayama-shi (JP); Hiroshi MIZUHATA, Wakayama-shi (JP)

(73) Assignee: KAO CORPORATION, Tokyo (JP)

(21) Appl. No.: 18/007,172

(22) PCT Filed: Dec. 3, 2020
(86) PCT No.: PCT/JP2020/045127

§ 371 Date: Jan. 27, 2023

(30) Foreign Application Priority Data
Jul. 30, 2020 (JP) 2020-129517

(51) Int. Cl. G03G 9/087; G03G 9/08

(52) U.S. Cl. CPC G03G 9/087; G03G 9/0804

(57) ABSTRACT

A method of producing a resin particle dispersion for toner, including, cooling a mixture including a resin particle dispersion containing an amorphous resin and a crystalline resin, and an aqueous medium. Where the cooling includes together fluidizing, continuously mixing, and continuously discharging the mixture of the resin particle dispersion and the aqueous medium.

### FIELD OF THE INVENTION

The present invention relates to a method of producing a resin particle dispersion for toner, and more particularly, a method of producing a resin particle dispersion for toner used in an electrophotographic toner used in an electrophotographic method, an electrostatic recording method, an electrostatic printing method, etc.

### BACKGROUND OF THE INVENTION

In the field of electrophotographic toner, with the progress of electrophotographic systems, it has been demanded to develop toners that are adaptable for higher image quality and high copying or printing speed. From the viewpoint of high image quality, it is necessary to reduce the particle size of the toner, and a so-called chemical toner, which is obtained by chemical methods such as a polymerization method and an emulsification dispersion method, instead of conventional melt-kneading methods, has been developed. In the production of chemical toners, generally, an aqueous dispersion of resin particles and an aggregating agent are stirred and mixed under heating to agglomerate and coalesce the particles, followed by cooling.

For example, JP 2018-22132 A (PTL 1) discloses, with an object to obtain a toner excellent in low-temperature fixing property and capable of suppressing the deterioration of low-temperature fixing property over time, a method of producing a toner for developing an electrostatic charge image, including a step of cooling a dispersion of toner particles containing an amorphous resin (A) and a crystalline resin (B), wherein the step of cooling satisfies specific temperature conditions.

In addition, JP 2018-13589 A (PTL 2) discloses, for the same problem as in PTL 1, a method of producing a toner for developing an electrostatic charge image, including step (1): a step of aggregating an amorphous composite resin and a crystalline resin in an aqueous medium to obtain a dispersion of aggregated particles, step (2): a step of coalescing the obtained aggregated particles to form a dispersion of coalesced particles, and step (3): a step of cooling the obtained dispersion of coalesced particles at a rate of 10° C./min or more, wherein the amorphous composite resin includes a polyester-based resin segment and a vinyl-based resin segment containing a structural unit derived from a vinyl monomer having a hydrocarbon group having 6 to 22 carbon atoms.

### SUMMARY OF THE INVENTION

The present invention relates to the following [1] and [2].

[1] A method of producing a resin particle dispersion for toner, including a step of cooling a resin particle dispersion containing an amorphous resin and a crystalline resin, and an aqueous medium by together fluidizing and continuously mixing the resin particle dispersion and the aqueous medium.

[2] A method of producing a toner for developing an electrostatic charge image, including the production method according to [1].

### DETAILED DESCRIPTION OF THE INVENTION

In PTLs 1 and 2, since it is difficult to rapidly lower the temperature of the dispersion of the coalesced particles for the toner particles, crystal domains derived from the crystalline resin in the toner particles tend to grow large.

The present invention relates to providing a method of producing a resin particle dispersion for toner, whereby a toner having superior low-temperature fixing property can be obtained.

In the present invention, it has been found that a resin particle dispersion for toner, by which a toner excellent in low-temperature fixing property can be obtained, can be obtained by adopting a specific cooling step.

That is, the present invention relates to [1] and [2] above.

According to the production method of the present invention, it is possible to obtain a resin particle dispersion for toner, whereby a toner excellent in low-temperature fixing property can be obtained.

[Method of Producing Resin Particle Dispersion for Toner]

The method of producing a resin particle dispersion for toner of the present invention includes a step of cooling a resin particle dispersion containing an amorphous resin (hereinafter also referred to as amorphous resin (A)) and a crystalline resin (hereinafter also referred to as crystalline resin (B)), and an aqueous medium by together fluidizing and continuously mixing the resin particle dispersion and the aqueous medium.

In the resin particle dispersion containing (A) an amorphous resin and (B) a crystalline resin used in the present invention, the particles may be obtained by any conventionally known method such as a melt-kneading method, an emulsification phase-transfer method, a polymerization method, and an aggregating and coalescing method; however, particles obtained by the aggregating and coalescing method are preferred.

In the case of the aggregating and coalescing method, the production method includes, for example,

step 1: a step of aggregating the amorphous resin (A) and the crystalline resin (B) in an aqueous medium to obtain a dispersion of aggregated particles (hereinafter also simply referred to as “step 1”);

step 2: a step of heating and coalescing the obtained aggregated particles in an aqueous medium to obtain a dispersion of coalesced particles (resin particle dispersion) (hereinafter also simply referred to as “step 2”); and

step 3: a step of cooling the obtained resin particle dispersion containing the amorphous resin (A) and the crystalline resin (B), and an aqueous medium by together fluidizing and continuously mixing the resin particle dispersion and the aqueous medium to obtain a resin particle dispersion for toner (hereinafter also simply referred to as “step 3”).

As described in PTLs 1 and 2, in a method of adding a dispersion of coalesced particles for toner particles to cold water or adding cold water to a dispersion of coalesced particles for toner particles, the temperature of the cold water or the dispersion gradually changes as adding them, and thus the size of the crystal domain varies, resulting in large particles of the crystal domain.

It is believed that during toner fixing, structural defects occur at the boundary between the amorphous resin and the crystalline resin, which promotes fixing. Therefore, when the crystal domain of the crystalline resin becomes larger, the boundary area is reduced, and as a result, the meltability of the crystalline resin during toner fixing is reduced, and the low-temperature fixing property is reduced.

In the present invention, the resin particle dispersion containing the amorphous resin (A) and the crystalline resin (B), and the aqueous medium are made to flow together and are continuously mixed and cooled, and thus it is considered that the expansion of crystal domains in the resin particles can be suppressed by cooling in a short period of time.

In addition, since the temperature of the resin particle dispersion and the temperature of the aqueous medium to be mixed are constant, resin particle dispersions for toner of the same quality can be obtained at all times. Therefore, it is believed that this is because the variation in the size of the crystal domains among the resin particles is suppressed.

For these reasons, it is believed that according to the production method of the present invention, a resin particle dispersion for toner with improved low-temperature fixing property can be obtained.

<Step 1>

Step 1 is a step of aggregating the amorphous resin (A) and the crystalline resin (B) in an aqueous medium to obtain a dispersion of aggregated particles.

The resin constituting the resin particles is not particularly limited as long as it can form an aqueous dispersion. However, from the viewpoint of the low-temperature fixing property and chargeability of the toner, it is preferably a polyester-based resin.

That is, the resin particles contain the amorphous resin (A) and the crystalline resin (B), and preferably contain an amorphous polyester-based resin and a crystalline polyester-based resin.

Here, whether or not a resin is crystalline or amorphous can be determined by the crystallinity index of the resin. The crystallinity index is defined by a ratio of a softening point of a resin to a temperature at the endothermic maximum peak thereof (softening point (° C.)/endothermic maximum peak temperature (° C.)) in the measurement method described in the section of Examples described later. A crystalline resin is one having a crystallinity index of 0.6 or more and 1.4 or less. An amorphous resin is one having a crystallinity index of less than 0.6 or more than 1.4. The crystallinity index can be appropriately controlled, depending on the kind and the ratio of the raw material monomer used, and on the production condition such as the reaction temperature, the reaction time and the cooling speed.

(Amorphous Resin (A))

The amorphous resin (A) is, from the viewpoint of obtaining a toner exhibiting low-temperature fixing property, image density of prints, and hot offset resistance, preferably a polyester-based resin, more preferably a polyester-based resin having a component derived from a hydrocarbon wax W1 having at least one of a hydroxy group and a carboxy group, and a polyester resin segment. The amorphous resin (A) is preferably, for example, a resin obtained by polycondensing an alcohol component and a carboxylic acid component in the presence of the hydrocarbon wax W1 having at least one of a hydroxy group and a carboxy group.

The amorphous resin (A) more preferably has a component derived from the hydrocarbon wax W1 having at least one of a hydroxy group and a carboxy group, a polyester resin segment, and an addition polymerization resin segment from the viewpoint of further improving the low-temperature fixing property, image density of prints, and hot offset resistance.

[Structural Unit Derived from Hydrocarbon Wax W1]

The “structural unit derived from the hydrocarbon wax W1” means a residual component of the hydrocarbon wax W1 in which at least one of the hydroxy group and the carboxy group of the hydrocarbon wax reacts and bonds to a polyester resin segment via a covalent bond.

The hydrocarbon wax W1 has at least one of a carboxy group and a hydroxy group. The hydrocarbon wax W1 may have any one or both of a hydroxy group and a carboxy group, but preferably has a hydroxy group and a carboxy group from the viewpoint of improving the low-temperature fixing property, the image density of prints and from the viewpoint of improving hot offset resistance.

The hydrocarbon wax W1 can be produced, for example, by modifying an unmodified hydrocarbon wax according to a known method. Examples of a raw material for the hydrocarbon wax W1 include paraffin wax, Fischer-Tropsch wax, microcrystalline wax, polyethylene wax, and polypropylene wax. Among these, paraffin wax and Fischer-Tropsch wax are preferred.

Examples of commercial products of paraffin wax and Fischer-Tropsch wax, which are the raw materials of the hydrocarbon wax W1, include “HNP-11”, “HNP-9”, “HNP-10”, “FT-0070”, “HNP-51”, and “FNP-0090” (all from Nippon Seiro Co., Ltd.).

A hydrocarbon wax having a hydroxy group may be obtained, for example, by modifying a hydrocarbon wax such as paraffin wax and Fischer-Tropsch wax by oxidation treatment. Examples of an oxidation treatment method include the methods described in JPS 62-79267 A and JP 2010-197979 A. Specifically, a method of liquid-phase oxidizing a hydrocarbon wax with an oxygen-containing gas in the presence of boric acid may be exemplified.

Examples of commercial products of hydrocarbon wax having a hydroxy group include “Unilin 700”, “Unilin 425” and “Unilin 550” (all from Baker Petrolite Corporation).

Examples of hydrocarbon wax having a carboxy group include an acid-modified hydrocarbon wax.

An acid-modified hydrocarbon wax may be obtained, for example, by introducing a carboxy group into a hydrocarbon wax such as paraffin wax and Fischer-Tropsch wax by acid modification. Examples of an acid modification method include the methods described in JP 2006-328388 A and JP 2007-84787 A. Specifically, a carboxy group may be introduced by adding an organic peroxide such as dicumyl peroxide as a reaction initiator and a carboxylic acid compound having an unsaturated bond to a melt of the raw material hydrocarbon wax and reacting the mixture.

Examples of commercial products of hydrocarbon wax having a carboxy group include a maleic anhydride-modified ethylene-propylene copolymer “HI-WAX 1105A” (from Mitsui Chemicals Inc.).

A hydrocarbon wax having a hydroxy group and a carboxy group can be obtained, for example, by a method similar to oxidation treatment of a hydrocarbon wax having a hydroxy group.

Examples of commercial products of hydrocarbon wax having a hydroxy group and a carboxy group include “Paracol 6420”, “Paracol 6470” and “Paracol 6490” (all from Nippon Seiro Co., Ltd.).

[Polyester Resin Segment]

The polyester resin segment is, for example, a segment consisting of a polyester resin, which is a polycondensate of an alcohol component and a carboxylic acid component.

Each component of the polyester resin segment of the amorphous resin (A) will be described below.

Examples of the alcohol component include a diol having an aromatic group, a linear or branched aliphatic diol, an alicyclic diol, and a trihydric or higher polyalcohol. Among these, an aromatic diol is preferred.

The diol having an aromatic group is preferably an alkylene oxide adduct of bisphenol A, more preferably an alkylene oxide adduct of bisphenol A represented by the following formula (I):

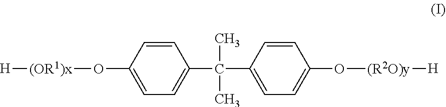

wherein R¹O and OR² each represent an oxyalkylene group, R¹ and R² each independently represent an ethylene group or a propylene group, x and y each represents an average molar number of addition of an alkylene oxide, and each are a positive number, a sum of x and y is 1 or more, preferably 1.5 or more, more preferably 2 or more, and is 16 or less, preferably 8 or less, more preferably 4 or less.

Examples of the alkylene oxide adduct of bisphenol A include a polyoxypropylene adduct of bisphenol A [2,2-bis(4-hydroxyphenyl)propane], and a polyoxyethylene adduct of bisphenol A. It is preferable to use one alone or two or more of these.

The content of the alkylene oxide adduct of bisphenol A is, in the alcohol component, preferably 70 mol % or more, more preferably 80 mol % or more, still more preferably 90 mol % or more, even more preferably 95 mol % or more, and is 100 mol % or less, further more preferably 100 mol %.

Examples of the carboxylic acid component include a dicarboxylic acid and a trivalent or higher polycarboxylic acid.

Examples of the dicarboxylic acid include an aromatic dicarboxylic acid, a linear or branched aliphatic dicarboxylic acid, and an alicyclic dicarboxylic acid. Among these, at least one selected from an aromatic dicarboxylic acid and a linear or branched aliphatic dicarboxylic acid is preferred.

Examples of the aromatic dicarboxylic acid include phthalic acid, isophthalic acid, and terephthalic acid. Among these, isophthalic acid and terephthalic acid are preferred, and terephthalic acid is more preferred.

The amount of the aromatic dicarboxylic acid is, in the carboxylic acid component, preferably 20 mol % or more, more preferably 30 mol % or more, even more preferably 40 mol % or more, and is preferably 95 mol % or less, more preferably 90 mol % or less, even more preferably 80 mol % or less.

The carbon number of the linear or branched aliphatic dicarboxylic acid is preferably 2 or more, more preferably 3 or more, and is preferably 30 or less, more preferably 20 or less.

Examples of the linear or branched aliphatic dicarboxylic acid include oxalic acid, malonic acid, maleic acid, fumaric acid, citraconic acid, itaconic acid, glutaconic acid, succinic acid, adipic acid, sebacic acid, dodecanedioic acid, azelaic acid, and succinic acid substituted with an alkyl group having 1 or more and 20 or less carbon atoms or an alkenyl group having 2 or more and 20 or less carbon atoms. Examples of the succinic acid substituted with an alkyl group having 1 or more and 20 or less carbon atoms or an alkenyl group having 2 or more and 20 or less carbon atoms include dodecylsuccinic acid, dodecenylsuccinic acid and octenylsuccinic acid. Among these, fumaric acid and succinic acid substituted with an alkyl group having 1 or more and 20 or less carbon atoms or an alkenyl group having 2 or more and 20 or less carbon atoms are preferable, and fumaric acid is more preferable.

The amount of the linear or branched aliphatic dicarboxylic acid is, in the carboxylic acid component, preferably 1 mol % or more, more preferably 2 mol % or more, even more preferably 3 mol % or more, and is preferably 30 mol % or less, more preferably 20 mol % or less, even more preferably 10 mol % or less.

The trivalent or higher polycarboxylic acid is preferably a trivalent carboxylic acid, and examples thereof include trimellitic acid.

In the case of containing a trivalent or higher polycarboxylic acid, the amount of the trivalent or higher polycarboxylic acid is, in the carboxylic acid component, preferably 3 mol % or more, more preferably 5 mol % or more, even more preferably 10 mol % or more, and is preferably 30 mol % or less, more preferably 25 mol % or less, even more preferably 20 mol % or less.

One alone or a combination of two or more kinds of these carboxylic acid components may be used.

The ratio of the carboxy group in the carboxylic acid component to the hydroxy group in the alcohol component [COOH group/OH group] is preferably 0.7 or more, more preferably 0.8 or more, and is preferably 1.3 or less, more preferably 1.2 or less.

[Addition Polymerization Resin Segment]

The addition polymerization resin segment is preferably an addition polymerized product of a raw material monomer containing a styrenic compound, from the viewpoint of improving the low-temperature fixing property and image density of prints.

The styrenic compound includes a substituted or unsubstituted styrene. Examples of the substituent include an alkyl group having 1 or more and 5 or less carbon atoms, a halogen atom, an alkoxy group having 1 or more and 5 or less carbon atoms, and a sulfonic group or a salt thereof.

Examples of the styrenic compound include styrene, methylstyrene, α-methylstyrene, β-methylstyrene, tert-butylstyrene, chlorostyrene, chloromethylstyrene, methoxystyrene, and styrenesulfonic acid or a salt thereof. Among these, styrene is preferred.

In the raw material vinyl monomer for the addition polymerization resin segment, the content of the styrenic compound is preferably 40% by mass or more, more preferably 50% by mass or more, still more preferably 60% by mass or more, even more preferably 70% by mass or more, and is preferably 95% by mass or less, more preferably 90% by mass or less, still more preferably 87% by mass or less, even more preferably 85% by mass or less, from the viewpoint of improving the low-temperature fixing property and image density of prints.

Examples of the other raw material monomer than the styrenic compound include (meth)acrylates such as alkyl (meth)acrylates, benzyl (meth)acrylate, and dimethylaminoethyl (meth)acrylate; olefins such as ethylene, propylene and butadiene; vinyl halides such as vinyl chloride; vinyl esters such as vinyl acetate and vinyl propionate; vinyl ethers such as vinyl methyl ether; vinylidene halides such as vinylidene chloride; N-vinyl compounds such as N-vinylpyrrolidone. Among these, (meth)acrylates are preferred, and alkyl (meth)acrylates are more preferred, from the viewpoint of improving the low-temperature fixing property and image density of prints, as well as from the viewpoint of improving hot offset resistance.

The carbon number of the alkyl group in the alkyl (meth)acrylate is, from the viewpoint of improving the low-temperature fixing property and image density of prints, as well as from the viewpoint of improving hot offset resistance, preferably 1 or more, more preferably 6 or more, even more preferably 10 or more, and is preferably 24 or less, more preferably 22 or less, even more preferably 20 or less.

From the viewpoint of improving the low-temperature fixing property and image density of prints, the raw material monomer for the addition polymerization resin segment preferably consists of styrene or contains styrene and (meth)acrylate, more preferably contains styrene and (meth)acrylate, and further more preferably contains styrene and an alkyl (meth)acrylate having an alkyl group having 6 to 20 carbon atoms.

In the raw material vinyl monomer for the addition polymerization resin segment, the content of the (meth)acrylate is, from the viewpoint of improving the low-temperature fixing property and image density of prints, preferably 5% by mass or more, more preferably 10% by mass or more, even more preferably 15% by mass or more, further more preferably 17% by mass or more, and is preferably 60% by mass or less, more preferably 50% by mass or less, even more preferably 40% by mass or less.

The total content of the styrenic compound and the (meth)acrylate in the raw material monomer for the addition polymerization resin segment is, from the viewpoint of improving the low-temperature fixing property and image density of prints, preferably 80% by mass or more, more preferably 90% by mass or more, even more preferably 95% by mass or more, and is 100% by mass or less, more preferably 100% by mass.

When the amorphous resin (A) has an addition polymerization resin segment, the amorphous resin (A) preferably has a structural unit derived from a bireactive monomer bonding to the polyester resin segment and the addition polymerization resin segment via a covalent bond. “Structural unit derived from a bireactive monomer” means a unit formed through reaction of the functional group and the unsaturated bond site of a bireactive monomer.

Examples of the bireactive monomer include an addition-polymerizing monomer having at least one functional group selected from a hydroxy group, a carboxy group, an epoxy group, a primary amino group and a secondary amino group in the molecule. Among these, from the viewpoint of reactivity, an addition-polymerizing monomer having a hydroxy group or a carboxy group is preferred, and an addition-polymerizing monomer having a carboxy group is more preferred.

Examples of the bireactive monomer include acrylic acid, methacrylic acid, fumaric acid and maleic acid. Among these, from the viewpoint of reactivity in both polycondensation reaction and addition polymerization reaction, acrylic acid and methacrylic acid are preferred, and acrylic acid is more preferred.

The amount of the structural unit derived from the bireactive monomer is, relative to 100 parts by mol of the alcohol component of the polyester resin segment of the amorphous resin (A), preferably 1 part by mol or more, more preferably 5 parts by mol or more, even more preferably 8 parts by mol or more, and is preferably 30 parts by mol or less, more preferably 25 parts by mol or less, even more preferably 20 parts by mol or less.

The amount of the component derived from the hydrocarbon wax W1 in the amorphous resin (A) is, from the viewpoint of further improving the low-temperature fixing property and image density of prints and from the viewpoint of further improving the hot offset resistance, preferably 1% by mass or more, more preferably 2% by mass or more, even more preferably 3% by mass or more, and is preferably 15% by mass or less, more preferably 12% by mass or less, even more preferably 10% by mass or less.

The amount of the polyester resin segment in the amorphous resin (A) is, from the viewpoint of further improving the low-temperature fixing property and image density of prints and from the viewpoint of further improving the hot offset resistance, preferably 40% by mass or more, more preferably 50% by mass or more, even more preferably 60% by mass or more, further more preferably 70% by mass or more, still more preferably 80% by mass or more, still further more preferably 90% by mass or more, and is preferably 99% by mass or less, more preferably 98% by mass or less, and when containing the addition polymerization resin segment which will be described later, preferably 80% by mass or less, more preferably 70% by mass or less, even more preferably 60% by mass or less.

The amount of the addition polymerization resin segment in the amorphous resin (A) is, from the viewpoint of further improving the low-temperature fixing property and image density of prints, preferably 10% by mass or more, more preferably 15% by mass or more, even more preferably 20% by mass or more, further more preferably 25% by mass or more, still more preferably 35% by mass or more, and is preferably 60% by mass or less, more preferably 50% by mass or less, even more preferably 45% by mass or less.

The amount of the structural unit derived from the bireactive monomer in the amorphous resin (A) is preferably 0.1% by mass or more, more preferably 0.5% by mass or more, even more preferably 0.8% by mass or more, and is preferably 10% by mass or less, more preferably 5% by mass or less, even more preferably 3% by mass or less.

The total amount of the hydrocarbon wax W1-derived component, the polyester resin segment, the addition polymerization resin segment, and the bireactive monomer-derived structural unit in the amorphous resin (A) is preferably 80% by mass or more, more preferably 90% by mass or more, even more preferably 93% by mass or more, still more preferably 95% by mass or more, and is 100% by mass or less.

The above-mentioned amount is calculated based on the quantitative ratio of the raw material monomers for the polyester resin segment and the addition polymerization resin segment, the bireactive monomer, and a radical polymerization initiator used, and the dehydration amount in polycondensation for the polyester resin segment and others is not considered. In the case where a radical polymerization initiator is used, the mass of the radical polymerization initiator is included and calculated in the addition polymerization resin segment.

[Production of Amorphous Resin (A)]

The amorphous resin (A) may be obtained, for example, by polycondensation of an alcohol component and a carboxylic acid component in the presence of the hydrocarbon wax W1 having a hydroxy group or a carboxy group.

As needed, polycondensation may be carried out in the presence of an esterification catalyst such as tin(II) di(2-ethylhexanoate), dibutyltin oxide, or titanium diisopropylate bistriethanolaminate in an amount of 0.01 parts by mass or more and 5 parts by mass or less relative to the total amount, 100 parts by mass of the alcohol component and the carboxylic acid component, along with an esterification promoter such as gallic acid (same as 3,4,5-trihydroxybenzoic acid) in an amount of 0.001 parts by mass or more and 0.5 parts by mass or less relative to the total amount, 100 parts by mass of the alcohol component and the carboxylic acid component.

The polycondensation reaction temperature is preferably 120° C. or higher, more preferably 160° C. or higher, even more preferably 180° C. or higher, and is preferably 250° C. or lower, more preferably 230° C. or lower. Polycondensation may be carried out in an inert gas atmosphere.

When the amorphous resin (A) has an addition polymerization resin segment, the amorphous resin (A) may be produced, for example, in the presence of the hydrocarbon wax W1, according to a method that includes a step A of polycondensation reaction of an alcohol component and a carboxylic acid component, and a step B of addition polymerization reaction with a raw material monomer for the addition polymerization resin segment and a bireactive monomer.

The step B may be carried out after the step A, or the step A may be carried out after the step B, or the step A and the step B may be carried out simultaneously.

In the step A, preferably, a part of a carboxylic acid component is subjected to polycondensation reaction, then the step B is carried out, and thereafter the reaction temperature is raised again, the remaining part of the polyvalent carboxylic acid component is added to the polymerization system, and the polycondensation reaction in the step A and optionally reaction with a bireactive monomer are further carried out.

[Properties of Amorphous Resin (A)]

The softening point of the amorphous resin (A) is, from the viewpoint of further improving the low-temperature fixing property and image density of prints and from the viewpoint of further improving the hot offset resistance, preferably 70° C. or higher, more preferably 90° C. or higher, even more preferably 100° C. or higher, still more preferably 110° C. or higher, and is preferably 140° C. or lower, more preferably 135° C. or lower, even more preferably 130° C. or lower.

The glass transition temperature of the amorphous resin (A) is, from the viewpoint of further improving the low-temperature fixing property and image density of prints and from the viewpoint of further improving the hot offset resistance, preferably 30° C. or higher, more preferably 35° C. or higher, even more preferably 40° C. or higher, and is preferably 80° C. or lower, more preferably 70° C. or lower, even more preferably 65° C. or lower.

The acid value of the amorphous resin (A) is, from the viewpoint of further improving the low-temperature fixing property and image density of prints, preferably 5 mgKOH/g or more, more preferably 10 mgKOH/g or more, even more preferably 16 mgKOH/g or more, and is preferably 40 mgKOH/g or less, more preferably 35 mgKOH/g or less, even more preferably 30 mgKOH/g or less.

The softening point, the glass transition temperature and the acid value of the amorphous resin (A) can be appropriately controlled, depending on the kind and the ratio of the raw material monomer used, and on the production conditions such as the reaction temperature, the reaction time and the cooling speed, and the values can be determined according to the methods described in the section of Examples.

In the case where two or more kinds of the amorphous resin (A) are used as combined, preferably, the softening point, the glass transition temperature and the acid value of the mixture each fall within the above-mentioned range.

(Crystalline Resin (B))

Examples of the crystalline resin (B) include a crystalline polyester resin. The crystalline polyester resin is a polycondensate of an alcohol component and a carboxylic acid component.

The alcohol component is preferably an α,ω-aliphatic diol. The carbon number of the α,ω-aliphatic diol is preferably 2 or more, more preferably 4 or more, even more preferably 6 or more, and is preferably 16 or less, more preferably 14 or less, even more preferably 12 or less. Examples of the α,ω-aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, and 1,14-tetradecanediol. Among these, 1,6-hexanediol, 1,10-decanediol and 1,12-dodecanediol are preferred, and 1,10-decanediol is more preferred.

The amount of the α,ω-aliphatic diol in the alcohol component is preferably 80 mol % or more, more preferably 85 mol % or more, even more preferably 90 mol % or more, still more preferably 95 mol % or more, and is 100 mol % or less, more preferably 100 mol %.

The alcohol component may contain other alcohol components different from the α,ω-aliphatic diol.

The carboxylic acid component is preferably an aliphatic dicarboxylic acid. The carbon number of the aliphatic dicarboxylic acid is preferably 4 or more, more preferably 8 or more, still more preferably 10 or more, and is preferably 14 or less, more preferably 12 or less. Examples of the aliphatic dicarboxylic acid include fumaric acid, sebacic acid, dodecanedioic acid, and tetradecanedioic acid. Among these, sebacic acid and dodecanedioic acid are preferred, and sebacic acid is more preferred. One alone or a combination of two or more kinds of these carboxylic acid components can be used.

The amount of the aliphatic dicarboxylic acid is, in the carboxylic acid component, preferably 80 mol % or more, more preferably 85 mol % or more, even more preferably 90 mol % or more, still more preferably 95 mol % or more, and is 100 mol % or less, more preferably 100 mol %.

The carboxylic acid component may contain other carboxylic acid components different from the aliphatic dicarboxylic acid.

The ratio of the carboxy group in the carboxylic acid component to the hydroxy group in the alcohol component [COOH group/OH group] is preferably 0.7 or more, more preferably 0.8 or more, and is preferably 1.3 or less, more preferably 1.2 or less.

The crystalline resin (B) may be obtained, for example, by polycondensation of an alcohol component and a carboxylic acid component. The conditions for the polycondensation reaction are as shown in the method of producing the amorphous resin (A) described above.

[Properties of Crystalline Resin (B)]

The softening point of the crystalline resin (B) is, from the viewpoint of improving the low-temperature fixing property and image density of prints, preferably 60° C. or higher, more preferably 70° C. or higher, even more preferably 80° C. or higher, and is, from the viewpoint of improving the image density of prints and hot offset resistance, preferably 150° C. or lower, more preferably 120° C. or lower, even more preferably 100° C. or lower.

The melting point of the crystalline resin (B) is, from the viewpoint of improving the low-temperature fixing property and image density of prints, preferably 50° C. or higher, more preferably 60° C. or higher, even more preferably 65° C. or higher, and is preferably 100° C. or lower, more preferably 90° C. or lower, even more preferably 80° C. or lower.

The acid value of the crystalline resin (B) is, from the viewpoint of improving the dispersion stability of resin particles (Y) described later, preferably 5 mgKOH/g or more, more preferably 10 mgKOH/g or more, even more preferably 15 mgKOH/g or more, and is preferably 35 mgKOH/g or less, more preferably 30 mgKOH/g or less, even more preferably 25 mgKOH/g or less.

The softening point, the melting point and the acid value of the crystalline resin (B) can be appropriately controlled, depending on the kind and the ratio of the raw material monomer used, and on the production conditions such as the reaction temperature, the reaction time and the cooling speed, and the values can be determined according to the methods described in the section of Examples.

In the case where two or more kinds of the crystalline resin (B) are used as combined, preferably, the softening point, the melting point and the acid value of the mixture each fall within the above-mentioned range.

(Production of Crystalline Resin (B))

The crystalline resin (B) can be produced by a known method. However, for example, in the case of a crystalline polyester resin, the crystalline resin (B) can be produced by polycondensing an alcohol component and a carboxylic acid component in an inert gas atmosphere using, as necessary, an esterification catalyst, an esterification promoter, a radical polymerization inhibitor, etc.

The esterification catalyst, the esterification promoter, and the radical polymerization inhibitor can be similar to those described in the production of the amorphous resin (A) described above.

The amount of the esterification catalyst used is preferably 0.01 parts by mass or more, more preferably 0.1 parts by mass or more, and is preferably 5 parts by mass or less, more preferably 2 parts by mass or less relative to the total amount, 100 parts by mass of the alcohol component and the carboxylic acid component.

The polycondensation reaction temperature is preferably 120° C. or higher, more preferably 160° C. or higher, even more preferably 180° C. or higher, and is preferably 250° C. or lower, more preferably 230° C. or lower, even more preferably 220° C. or lower.

(Aqueous Medium)

The aqueous medium is preferably one containing water as a main component, and from the viewpoint of improving the dispersion stability of the aqueous dispersion and from the viewpoint of environmental performance, the content of water in the aqueous medium is preferably 70% by mass or more, more preferably 80% by mass or more, even more preferably 90% by mass or more, and is 100% by mass or less. As water, deionized water, ion-exchanged water, or distilled water is preferred.

As the other component than water that may constitute the aqueous medium together with water, an organic solvent capable of dissolving in water, for example, an alkyl alcohol having 1 or more and 5 or less carbon atoms; a dialkyl ketone having 3 or more and 5 or less carbon atoms, such as acetone and methyl ethyl ketone; and a cyclic ether such as tetrahydrofuran may be used.

Among these, methyl ethyl ketone is preferred.

(Conditions of Step 1)

Step 1 preferably includes the following step 1-1, and may subsequently include step 1-2 in order to obtain toner particles having a core/shell structure.

Step 1-1: A step of aggregating resin particles (X) containing the amorphous resin (A) and the crystalline resin (B) in an aqueous medium to obtain aggregated particles (1)

Step 1-2: A step of adding the resin particles (Y) containing an amorphous resin (C) to the aggregated particles (1) obtained in Step 1-1 to obtain aggregated particles (2) in which the resin particles (Y) are adhered to the aggregated particles (1)

When the step (1) includes the step (1-1) and the step (1-2), the “obtained aggregated particles” in the step (2) means the “aggregated particles (2) obtained in the step (1-2)”. Further, when the step (1) includes only the step (1-1), the “obtained aggregated particles” in the step (2) means the “aggregated particles (1) obtained in the step (1-1)”.

(Step 1-1)

In the step 1-1, in addition to the amorphous resin (A) and the crystalline resin (B), optional components such as a wax (D), a colorant, an aggregating agent, and a surfactant may be aggregated in the aqueous medium as necessary.

In addition, the resin particles (X) may be obtained by aggregating an aqueous dispersion of the amorphous resin (A) and an aqueous dispersion of the crystalline resin (B), or may be obtained by aggregating an aqueous dispersion of a mixed resin containing the amorphous resin (A) and the crystalline resin (B) in advance, and is not particularly limited.

[Resin Particles (X)]

The resin particles (X) are obtained by, as an aqueous dispersion, dispersing a resin component containing the amorphous resin (A) and the crystalline resin (B), and, when necessary, optional components such as a colorant (hereinafter, the resin component and optional components are collectively referred to as “resin component and the like”) in an aqueous medium.

Examples of a method of obtaining an aqueous dispersion of the resin particles (X) include a method in which a resin component and the like are added to an aqueous medium and are subjected to dispersion treatment using a disperser or the like; and a method of phase-transfer emulsification by gradually adding an aqueous medium to a melt or an organic solvent solution of the resin component and the like (phase-transfer emulsification). Among these methods, the method using phase-transfer emulsification is preferable from the viewpoints of excellent low-temperature fixing property, suppression of deterioration in low-temperature fixing property over time, and excellent heat-resistant storability.

Examples of the phase-transfer emulsification method include a method (a) of phase-transfer emulsification by dissolving a resin component and the like in an organic solvent and adding an aqueous medium to the resulting solution, and a method (b) of phase-transfer emulsification by adding an aqueous medium to a resin mixture obtained by melting and mixing the resin component and the like. The method (a) is preferred from the viewpoint of obtaining a homogeneous aqueous dispersion of the resin particles (X).

In the method (a), it is preferable to first dissolve the resin component and the like in an organic solvent to obtain an organic solvent solution of the resin component and the like, and then add an aqueous medium to the solution for phase-transfer emulsification.

The organic solvent used in the phase-transfer emulsification method is preferably at least one selected from a ketone-based solvent and an acetate solvent, more preferably at least one selected from methyl ethyl ketone, ethyl acetate and isopropyl acetate, and even more preferably methyl ethyl ketone.

The mass ratio of the organic solvent to the resin constituting the resin particles (X) (organic solvent/resin constituting the resin particles (X)) is, from the viewpoint of dissolving the resin and facilitating the phase transfer to the aqueous medium and from the viewpoint of improving the dispersion stability of the resin particles (X), preferably 0.1 or more, more preferably 0.2 or more, still more preferably 0.4 or more, and is preferably 4 or less, more preferably 2 or less, still more preferably 1.5 or less.

In the phase-transfer emulsification method, it is preferable to treat the resin with a neutralizing agent.

Examples of the neutralizing agent include a basic substance. Examples of the basic substance include an alkali metal hydroxide such as lithium hydroxide, sodium hydroxide and potassium hydroxide; and a nitrogen-containing basic substance such as ammonia, trimethylamine, ethylamine, diethylamine, triethylamine, diethanolamine, triethanolamine, and tributylamine. Among these, from the viewpoint of improving the dispersion stability and aggregating property of the resin particles (X), the alkali metal hydroxide is preferred, and sodium hydroxide is more preferred.

The equivalent (mol %) of the neutralizing agent used relative to the acid groups of the resin is preferably 10 mol % or more, more preferably 30 mol % or more, and is preferably 150 mol % or less, more preferably 120 mol % or less, even more preferably 100 mol % or less.

The equivalent (mol %) of the neutralizing agent used can be determined according to the following expression. When the equivalent of the neutralizing agent used is 100 mol % or less, it is synonymous with the degree of neutralization. When the equivalent of the neutralizing agent used in the following expression exceeds 100 mol %, it means that the neutralizing agent is excessive with respect to the acid groups of the resin, and the degree of neutralization of the resin at this time is considered to be 100 mol %.

Equivalent of neutralizing agent used (mol %)=[{mass of neutralizing agent added (g)/equivalent of neutralizing agent}/[{weighted average acid value of resin (mgKOH/g)×mass of resin (g)}/(56×1,000)]]×100

From the viewpoint of improving the dispersion stability of the resin particles (X), the amount of the aqueous medium to be added in the phase-transfer emulsification method is, relative to 100 parts by mass of the resin component constituting the resin particles (X), preferably 100 parts by mass or more, more preferably 150 parts by mass or more, and is preferably 900 parts by mass or less, more preferably 600 parts by mass or less, even more preferably 400 parts by mass or less, still more preferably 250 parts by mass or less.

Further, the ratio by mass of the aqueous medium to the organic solvent (aqueous medium/organic solvent) is, from the viewpoint of improving the dispersion stability of the resin particles (X), preferably 20/80 or more, more preferably 50/50 or more, even more preferably 80/20 or more, and is preferably 97/3 or less, more preferably 93/7 or less, even more preferably 90/10 or less.

[Wax (D)]

In the step 1-1, it is preferable to aggregate wax particles containing the wax (D) together with the resin particles X and colorant particles.

Examples of wax include a polypropylene wax, a polyethylene wax, and a polypropylene-polyethylene copolymer wax; hydrocarbon waxes or oxides thereof such as a microcrystalline wax, a paraffin wax, a Fischer-Tropsch wax, and a Sasol wax; ester waxes such as a carnauba wax, a montan wax or deoxidized waxes thereof, and fatty acid ester waxes; fatty acid amides, fatty acids, higher alcohols, and fatty acid metal salts. One alone or two or more kinds thereof may be used.

The melting point of the wax is preferably 60° C. or higher, more preferably 70° C. or higher, and is preferably 160° C. or lower, more preferably 140° C. or lower, even more preferably 120° C. or lower, still more preferably 100° C. or lower.

The content of the wax is, in toner, preferably 0.1% by mass or more, more preferably 1% by mass or more, even more preferably 3% by mass or more, and is preferably 20% by mass or less, more preferably 15% by mass or less.

Preferably, the wax is, as a dispersion of wax particles, mixed and aggregated with resin particle dispersion and colorant particle dispersion to be contained in the aggregated particles.

The dispersion of wax particles can be prepared using a surfactant, but is preferably prepared by mixing wax with resin particles Z to be described later. By preparing wax particles by using wax and resin particles Z, the wax particles can be stabilized by the resin particles Z and therefore the wax can be dispersed in an aqueous medium without using a surfactant. It is considered that, in the dispersion of wax particles, the resin particles Z are so configured that a large number of them adhere to the surfaces of the wax particles.

The resin to constitute the resin particles Z for dispersing wax is preferably a polyester resin, and from the viewpoint of improving dispersibility of wax in an aqueous medium, is more preferably a composite resin having a polyester resin segment and an addition polymerization resin segment.

The solid content concentration of the wax particle dispersion is, from the viewpoint of improving toner productivity and from the viewpoint of improving the dispersion stability of the wax particle dispersion, preferably 5% by mass or more, more preferably 10% by mass or more, even more preferably 20% by mass or more, and is preferably 50% by mass or less, and more preferably 40% by mass or less.

The volume median particle diameter (DO of the wax particles is, from the viewpoint of obtaining uniform aggregated particles and from the viewpoint of improving the low-temperature fixing property and image density of prints, preferably 0.1 μm or more, more preferably 0.2 μm or more, even more preferably 0.3 μm or more, and is preferably 1 μm or less, more preferably 0.8 μm or less, even more preferably 0.6 μm or less.

The CV value of the wax particles is, from the viewpoint of improving toner productivity, preferably 10% or more, more preferably 25% or more, and is, from the viewpoint of obtaining uniform aggregated particles, preferably 50% or less, more preferably 45% or less, even more preferably 42% or less.

The volume median particle diameter (D₅₀) and the CV value of the wax particles are specifically determined according to the methods described in the section of Examples.

[Colorant]

Examples of the colorant include pigments and dyes, and pigments are preferable from the viewpoint of improving the low-temperature fixing property and image density of prints. Examples of the pigments include cyan pigments, yellow pigments, magenta pigments, and black pigments. The cyan pigment is preferably a phthalocyanine pigment, more preferably a copper phthalocyanine. The yellow pigment is preferably a monoazo pigment, an isoindoline pigment, and a benzimidazolone pigment. The magenta pigment is preferably a quinacridone pigment, a soluble azo pigment such as a BONA lake pigment, or an insoluble azo pigment such as a naphthol AS pigment. The black pigment is preferably carbon black. Examples of dyes include acridine dyes, azo dyes, benzoquinone dyes, azine dyes, anthraquinone dyes, indigo dyes, phthalocyanine dyes, and aniline black dyes. One alone or a combination of two or more kinds of these colorants may be used.

The colorant is preferably added as colorant particles.

Examples of a method of producing colorant particles include a method of dispersing a colorant and an aqueous medium in the presence of a surfactant or the like using a disperser. Examples of the disperser include a homogenizer, and an ultrasonic disperser. Preferred aspects of the aqueous medium are the same as of the aqueous medium used for the aqueous dispersion of resin particles (X).

Examples of the dispersers include a homomixer, a homogenizer, and an ultrasonic disperser. Examples of commercial products of suitable dispersers include, a homomixer “T.K. AGI HOMOMIXER 2M-03” (from PRIMIX Corporation), high pressure homogenizers “Microfluidizer M-110EH” and “Microfluidizer M-7115” (from Microfluidics Corporation), and an ultrasonic homogenizer “US-600T” (from Nihonseiki Kaisha, Ltd.). One alone or two or more of these dispersers may be used.

The solid content concentration of the colorant particle dispersion is, from the viewpoint of improving toner productivity and from the viewpoint of improving the dispersion stability of the colorant particles dispersion, preferably 5% by mass or more, more preferably 10% by mass or more, even more preferably 20% by mass or more, and is preferably 50% by mass or less, more preferably 40% by mass or less, even more preferably 35% by mass or less.

The volume median particle diameter (DO of the colorant particles is, from the viewpoint of obtaining a toner capable of obtaining the low-temperature fixing property and high-quality images, preferably 0.050 μm or more, more preferably 0.080 μm or more, even more preferably 0.10 μm or more, and is preferably 0.50 μm or less, more preferably 0.30 μm or less, even more preferably 0.20 μm or less.

The CV value of the colorant particles is, from the viewpoint of improving toner productivity, preferably 10% or more, more preferably 25% or more, and is, from the viewpoint of obtaining uniform aggregated particles, preferably 50% or less, more preferably 45% or less, even more preferably 42% or less.

The volume median particle diameter (D₅₀) and the CV value of the colorant particles are specifically determined according to the methods described in the section of Examples.

[Aggregating Agent]

Examples of the aggregating agent include organic aggregating agents such as a cationic surfactant in the form of a quaternary ammonium salt and polyethyleneimine; and inorganic aggregating agents such as inorganic metal salts such as sodium sulfate, sodium nitrate, sodium chloride, calcium chloride, and calcium nitrate; inorganic ammonium salts such as ammonium sulfate, ammonium chloride, and ammonium nitrate; and divalent or higher metal complexes. From the viewpoint of improving aggregating property and obtaining uniform aggregated particles, monovalent or higher and pentavalent or lower inorganic aggregating agents are preferred, monovalent or higher and divalent or lower inorganic metal salts and inorganic ammonium salts are more preferred, inorganic ammonium salts are even more preferred, and ammonium sulfate is further more preferred.

From the viewpoint of controlling aggregation to obtain a desired particle size, the amount of the aggregating agent used is, relative to 100 parts by mass of resins constituting the resin particles (X) and the resin particles (Y), preferably 5 parts by mass or more, more preferably 10 parts by mass or more, even more preferably 20 parts by mass or more, and is, from the viewpoint of improving the low-temperature fixing property and heat-resistant storability of the toner, preferably 50 parts by mass or less, more preferably 45 parts by mass or less, even more preferably 40 parts by mass or less.

The aggregating agent is preferably added dropwise to the mixed dispersion as an aqueous solution. The aggregating agent may be added all at once, intermittently or continuously. Sufficient stirring is preferably performed during and after the addition.

In addition, from the viewpoint of controlling aggregation to obtain aggregated particles having a desired particle size and particle size distribution, the aqueous solution of the aggregating agent is preferably used with the pH of the aqueous solution adjusted to 7.0 or more and 9.0 or less.

The temperature at which the aggregating agent is dropped is, from the viewpoint of improving toner productivity, preferably 0° C. or higher, more preferably 10° C. or higher, even more preferably 20° C. or higher, and is preferably 45° C. or lower, more preferably 40° C. or lower, even more preferably 35° C. or lower, still more preferably 30° C. or lower.

Moreover, from the viewpoint of promoting aggregation and obtaining aggregated particles having a desired particle size and particle size distribution, it is preferable to raise the temperature of the dispersion after adding the aggregating agent. The temperature to be held is preferably 45° C. or higher, more preferably 50° C. or higher, even more preferably 55° C. or higher, and is preferably 70° C. or lower, more preferably 65° C. or lower, even more preferably 63° C. or lower.

It is preferable to check the progress of aggregation by monitoring the volume median particle diameter of the aggregated particles within the temperature ranges described above.

The volume median particle diameter (D₅₀) of the aggregated particles (1) is, from the viewpoint of excellent low-temperature fixing property and suppression of deterioration in low-temperature fixing property over time and excellent heat-resistant storability, preferably 2 μm or more, more preferably 3 μm or more, even more preferably 4 μm or more, and is preferably 10 μm or less, more preferably 8 μm or less, even more preferably 6 μm or less. The volume median particle diameter of the aggregated particles (1) can be determined according to the methods described in the section of Examples.

(Step 1-2)

[Amorphous Resin (C)]

When the step 1-2 is included, the amorphous resin (C) is a resin having a crystallinity index of more than 1.4 or less than 0.6. The crystallinity index can be controlled, depending on the kind and the ratio of the raw material monomer used, and on the production conditions (for example, the reaction temperature, the reaction time and the cooling speed), and the value thereof can be determined according to the methods described in the section of Examples.

The amorphous resin (C) is preferably a polyester resin obtained by polycondensation of an alcohol component (C-al) and a carboxylic acid component (C-ac) from the viewpoint of excellent low-temperature fixing property and suppression of deterioration in low-temperature fixing property over time, as well as from the viewpoint of excellent heat-resistant storability.

<<Alcohol Component (C-al)>>

From the viewpoint of obtaining excellent low-temperature fixing property and suppression of deterioration in low-temperature fixing property over time, and excellent heat-resistant storability, the alcohol component (C-al) preferably contains an alkylene oxide adduct of bisphenol A, more preferably contains an alkylene oxide adduct of bisphenol A represented by formula (I):

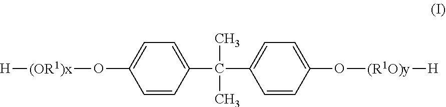

wherein OR¹ and R¹O each represent an alkylene oxide, R¹ represents an alkylene group having 2 or 3 carbon atoms, preferably an ethylene group, x and y each represents a positive number indicating an average molar number of addition of an alkylene oxide, a sum of x and y is 1 or more, preferably 1.5 or more, more preferably 2 or more, and is 16 or less, preferably 8 or less, more preferably 4 or less.

The alcohol component (C-al) preferably contains 80 mol % or more of the alkylene oxide adduct of bisphenol A. The content of the alkylene oxide adduct of bisphenol A in the alcohol component (C-al) is, from the viewpoint of excellent low-temperature fixing property and suppression of deterioration in low-temperature fixing property over time, and excellent heat-resistant storability, preferably 80 mol % or more, more preferably 90 mol % or more, even more preferably 95 mol % or more, still more preferably 98 mol % or more, and is 100 mol % or less, and more preferably 100 mol %.

The alkylene oxide adduct of bisphenol A is preferably a propylene oxide adduct of bisphenol A from the viewpoint of excellent low-temperature fixing property and suppression of deterioration in low-temperature fixing property over time, and excellent heat-resistant storability.

<<Carboxylic Acid Component (C-ac)>>

Examples of the carboxylic acid component (C-ac) include a dicarboxylic acid and a trivalent or higher polycarboxylic acid. Among these, a dicarboxylic acid is preferable, and it is more preferable to use a dicarboxylic acid and a trivalent or higher polycarboxylic acid in combination.

Examples of the dicarboxylic acid include an aromatic dicarboxylic acid, an aliphatic dicarboxylic acid, and an alicyclic dicarboxylic acid. At least one selected from an aromatic dicarboxylic acid and an aliphatic dicarboxylic acid is preferred, and an aromatic dicarboxylic acid is more preferred.

The carboxylic acid component (C-ac) includes not only free acids but also anhydrides that decompose during the reaction to produce acids, and alkyl esters of each carboxylic acid having 1 to 3 carbon atoms.

Examples of the aromatic dicarboxylic acid include phthalic acid, isophthalic acid, and terephthalic acid. From the viewpoint of excellent low-temperature fixing property and suppression of deterioration in low-temperature fixing property over time, and excellent heat-resistant storability, isophthalic acid and terephthalic acid are preferred, and terephthalic acid is more preferred.

The carbon number of the aliphatic dicarboxylic acid is preferably 2 or more, more preferably 3 or more, and is preferably 30 or less, more preferably 20 or less from the viewpoint of excellent low-temperature fixing property and suppression of deterioration in low-temperature fixing property over time, and excellent heat-resistant storability.

Among these, a succinic acid substituted with an alkyl group having 1 or more and 20 or less carbon atoms or an alkenyl group having 2 or more and 20 or less carbon atoms is preferable, and dodecenylsuccinic acid is more preferable. Further, from the viewpoint of excellent low-temperature fixing property and suppression of deterioration in low-temperature fixing property over time, and excellent heat-resistant storability, it is more preferable to use a succinic acid substituted with an alkyl group having 1 or more and 20 or less carbon atoms or an alkenyl group having 2 or more and 20 or less carbon atoms in combination with terephthalic acid, fumaric acid, adipic acid, sebacic acid, etc., and it is even more preferable to use terephthalic acid, fumaric acid, and dodecenylsuccinic acid in combination.

From the viewpoint of excellent low-temperature fixing property and suppression of deterioration in low-temperature fixing property over time, and excellent heat-resistant storability, the trivalent or higher polycarboxylic acid is preferably a trivalent carboxylic acid, more preferably at least one selected from a trimellitic acid and acid anhydrides thereof, even more preferably a trimellitic anhydride.

In addition, in the case of containing a trivalent or higher polycarboxylic acid, the content of the trivalent or higher polycarboxylic acid is, in the carboxylic acid component (C-ac), preferably 3 mol % or more, more preferably 5 mol % or more, and is preferably 30 mol % or less, more preferably 20 mol % or less from the viewpoint of excellent low-temperature fixing property and suppression of deterioration in low-temperature fixing property over time, and excellent heat-resistant storability.

One alone or a combination of two or more kinds of these carboxylic acid components (C-ac) may be used.

The molar equivalent ratio of the carboxy group (COOH group) in the carboxylic acid component (C-ac) to the hydroxy group (OH group) in the alcohol component (C-al) (COOH group/OH group) is, from the viewpoint of obtaining a resin having preferable thermophysical properties, preferably 0.7 or more, more preferably 0.8 or more, and is preferably 1.2 or less, more preferably 1.15 or less, even more preferably 1.12 or less.

The softening point of the amorphous resin (C) is, from the viewpoint of excellent low-temperature fixing property and suppression of deterioration in low-temperature fixing property over time, and excellent heat-resistant storability, preferably 90° C. or higher, more preferably 100° C. or higher, even more preferably 105° C. or higher, and is preferably 160° C. or lower, more preferably 140° C. or lower, even more preferably 120° C. or lower.

The glass transition temperature of the amorphous resin (C) is, from the viewpoint of excellent low-temperature fixing property and suppression of deterioration in low-temperature fixing property over time, and excellent heat-resistant storability, preferably 40° C. or higher, more preferably 50° C. or higher, even more preferably 60° C. or higher, and is preferably 90° C. or lower, more preferably 80° C. or lower, even more preferably 70° C. or lower.

The acid value of the amorphous resin (C) is, from the viewpoint of improving the dispersion stability of the resin particles (Y) to be described later, preferably 5 mgKOH/g or more, more preferably 10 mgKOH/g or more, even more preferably 15 mgKOH/g or more, and is preferably 35 mgKOH/g or less, more preferably 30 mgKOH/g or less, even more preferably 25 mgKOH/g or less.

The aforementioned softening point, the glass transition temperature and the acid value can be determined according to the methods described in the section of Examples. The softening point, the glass transition temperature and the acid value of the amorphous resin (C) can be appropriately controlled, depending on the kind and the ratio of the raw material monomer used, and on the production conditions such as the reaction temperature, the reaction time and the cooling speed.

In the case where two or more kinds of the amorphous resin (C) are used as combined, preferably, the softening point, the glass transition temperature and the acid value of the mixture each fall within the above-mentioned range.

[Resin Particles (Y)]

The resin particles (Y) are produced by dispersing a resin component containing the amorphous resin (C) in an aqueous medium to obtain an aqueous dispersion of the resin particles (Y).

The resin particles (Y) are preferably obtained as an aqueous dispersion of the resin particles (Y) by dispersing the resin component containing the amorphous resin (C) and, when necessary, the above optional components in an aqueous medium.

The method and suitable conditions for obtaining the aqueous dispersion are similar to those for the resin particles (X).

The solid content concentration of the aqueous dispersion of the resin particles (Y) is, from the viewpoint of improving toner productivity and from the viewpoint of improving the dispersion stability of the resin particles (Y), preferably 5% by mass or more, more preferably 15% by mass or more, even more preferably 30% by mass or more, and is preferably 50% by mass or less, and more preferably 40% by mass or less. The solid content is the total amount of non-volatile components such as resins and surfactants.

The volume median particle diameter (D₅₀) of the resin particles (Y) in the aqueous dispersion is, from the viewpoint of obtaining a toner capable of obtaining the low-temperature fixing property and high-quality images, preferably 0.05 μm or more, more preferably 0.08 μm or more, even more preferably 0.10 μm or more, and is preferably 0.50 μm or less, more preferably 0.30 μm or less, even more preferably 0.20 μm or less.

[Aggregated Particles (2)]

The step (1-2) is a step of adding the resin particles (Y) to the aggregated particles (1) obtained in the step (1-1) to obtain the aggregated particles (2) in which the resin particles (Y) are adhered to the aggregated particles (1). It is preferable to add an aqueous dispersion of the resin particles (Y) to the dispersion of the aggregated particles (1) to obtain a dispersion of the aggregated particles (2) in which the resin particles (Y) are further adhered to the aggregated particles (1).

Before adding the aqueous dispersion of the resin particles (Y) to the dispersion of the aggregated particles (1), an aqueous medium may be added to dilute the dispersion of the aggregated particles (1). Further, when the aqueous dispersion of the resin particles (Y) is added to the dispersion of the aggregated particles (1), the above-mentioned aggregating agents may be used in the step (1-2) in order to efficiently adhere the resin particles (Y) to the aggregated particles (1).

The temperature at which the aqueous dispersion of the resin particles (Y) is added is, from the viewpoint of obtaining uniform aggregated particles and from the viewpoint of excellent low-temperature fixing property, suppression of deterioration in low-temperature fixing property over time, and excellent heat-resistant storability, preferably 40° C. or higher, more preferably 45° C. or higher, even more preferably 50° C. or higher, and is preferably 80° C. or lower, more preferably 70° C. or lower, even more preferably 65° C. or lower.

The amount of the resin particles (Y) to be added is, from the viewpoint of excellent low-temperature fixing property, suppression of deterioration in low-temperature fixing property over time, and excellent heat-resistant storability, an amount such that the mass ratio of the resin particles (Y) to the resin particles (X) [(Y)/(X)] is preferably 0.05 or more, more preferably 0.10 or more, and is preferably 0.5 or less, more preferably 0.3 or less, even more preferably 0.2 or less, still more preferably 0.15 or less.

In the production method of the present invention, in addition to the amorphous resin (A), the crystalline resin (B), and the amorphous resin (C), known resins used in toners, such as styrene-acrylic copolymers, epoxies, polycarbonates, and polyurethanes can be contained within a range that does not impair the effects of the present invention. The mass ratio of the amorphous resin (A) to the crystalline resin (B) [(A)/(B)] is, from the viewpoint of improving the low-temperature fixing property and durability of the toner, preferably 5/5 or more, more preferably 6/4 or more, and is preferably 9/1 or less, more preferably 8/2 or less.

When performing the step (1-2), the total content of the amorphous resin (A), the crystalline resin (B), and the amorphous resin (C) is, from the viewpoint of excellent low-temperature fixing property, suppression of deterioration in low-temperature fixing property over time, and excellent heat-resistant storability, preferably 80% by mass or more, more preferably 90% by mass or more, even more preferably 95% by mass or more, still more preferably 98% by mass or more, further more preferably 100% by mass, relative to the total amount of the resin components of the toner.

Further, the mass ratio of the amorphous resin (C) to the total of the amorphous resin (A) and the crystalline resin (B) [(C)/((A)+(B))] is, from the viewpoint of improving the low-temperature fixing property and durability of the toner, preferably 0.05 or more, more preferably 0.10 or more, and is preferably 0.5 or less, more preferably 0.3 or less, even more preferably 0.2 or less, still more preferably 0.15 or less.

The mass ratio of the crystalline resin (B) to the total of the amorphous resin (A) and the amorphous resin (C) [(B)/((A)+(C))] is, from the viewpoint of improving the low-temperature fixing property and durability of the toner, preferably 0.1 or more, more preferably 0.2 or more, and is preferably 0.5 or less, more preferably 0.4 or less.

The volume median particle diameter (D₅₀) of the aggregated particles (2) is, from the viewpoint of obtaining a toner capable of obtaining high-quality images and from the viewpoint of excellent low-temperature fixing property, suppression of deterioration in low-temperature fixing property over time, and excellent heat-resistant storability, preferably 2 μm or more, more preferably 3 μm or more, even more preferably 4 μm or more, and is preferably 10 μm or less, more preferably 8 μm or less, even more preferably 6 μm or less.

In the step (1-2), at the time when the aggregated particles have grown to have a particle size suitable as a toner, the aggregation may be stopped.

As a method of stopping aggregation, there are mentioned a method of cooling the dispersion, a method of adding an aggregation stopping agent, a method of diluting the dispersion, etc. From the viewpoint of surely preventing any unnecessary aggregation, a method of adding an aggregation stopping agent to stop aggregation is preferred.

[Aggregation Stopping Agent]

A surfactant is preferred as the aggregation stopping agent, and an anionic surfactant is more preferred. Examples of the anionic surfactant include alkylbenzenesulfonate salts, alkyl sulfate salts, alkyl ether sulfate salts, and polyoxyalkylene alkyl ether sulfate salts. Polyoxyalkylene alkyl ether sulfate salts are preferred, polyoxyethylene lauryl ether sulfate salts are more preferred, and sodium polyoxyethylene lauryl ether sulfates are even more preferred.

One alone or a combination of two or more kinds of the aggregation stopping agents may be used.

The amount of the aggregation stopping agent to be added is, from the viewpoint of surely preventing unnecessary aggregation, preferably 0.1 parts by mass or more, more preferably 1 part by mass or more, even more preferably 5 parts by mass or more, still more preferably 10 parts by mass or more, further more preferably 20 parts by mass or more, and is, from the viewpoint of reducing the agent from remaining in toner, preferably 70 parts by mass or less, more preferably 60 parts by mass or less, even more preferably 55 parts by mass or less, relative to a total amount of 100 parts by mass of resin in the toner. The aggregation stopping agent is preferably added in the form of an aqueous solution from the viewpoint of improving toner productivity.

The temperature at which the aggregation stopping agent is added is preferably the same as the temperature at which the dispersion of the aggregated particles (2) is held, from the viewpoint of improving toner productivity. The temperature at which the aggregation stopping agent is added is preferably 40° C. or higher, more preferably 45° C. or higher, even more preferably 50° C. or higher, and is preferably 80° C. or lower, more preferably 70° C. or lower, even more preferably 65° C. or lower.

Further, from the viewpoint of stabilizing the aggregated particles and preventing the particles once aggregated from separating before being coalesced, it is preferable to add an acid at the same time as stopping the aggregation to make the dispersion of the aggregated particles neutral to acidic.

The acid to be added is not limited, and preferred examples thereof include a sulfuric acid, a hydrochloric acid, a nitric acid, a phosphoric acid, and an acetic acid. However, from the viewpoint of rapid pH change upon addition, the acid to be added is preferably at least one selected from a hydrochloric acid, a sulfuric acid, a nitric acid, and an acetic acid, more preferably at least one selected from a hydrochloric acid, a sulfuric acid, and a nitric acid, and still more preferably sulfuric acid.

The acid is preferably added in the form of an aqueous solution. Moreover, the acid may be added together with the aggregation stopping agent.

<Step 2>

The step 2 is a step of heating and coalescing the aggregated particles obtained in the step 1 in an aqueous medium to obtain a dispersion of coalesced particles (resin particle dispersion).

Among the aggregated particles, particles that were mainly in a state of being physically attached to each other are coalesced together to form coalesced particles. It is preferable to reduce the volume median particle diameter by coalescing.

The step 1 and step 2 may be performed continuously at the same heating temperature.

In the step 2, the temperature is preferably maintained at a temperature of that is lower by 15° C. than the melting point of the crystalline resin (B) or higher, from the viewpoint of improving the coalescing property of the aggregated particles and from the viewpoint of excellent low-temperature fixing property, suppression of deterioration in low-temperature fixing property over time, and excellent heat-resistant storability.

The maintained temperature is, from the viewpoint of improving the coalescing property of the aggregated particles and from the viewpoint of improving toner productivity, more preferably a temperature of that is lower by 10° C. than the melting point of the crystalline resin (B) or higher, even more preferably a temperature of that is lower by 8° C. than the melting point of the crystalline resin (B) or higher, still more preferably a temperature of that is lower by 5° C. than the melting point of the crystalline resin (B) or higher, further more preferably the melting point of the crystalline resin (B) or higher, and is preferably a temperature of that is higher by 30° C. than the melting point of the crystalline resin (B) or lower, more preferably a temperature of that is higher by 20° C. than the melting point of the crystalline resin (B) or lower, even more preferably a temperature of that is higher by 12° C. than the melting point of the crystalline resin (B)+12° C. or lower.

In this case, the holding time at a temperature of a temperature of that is lower by 15° C. than the melting point of the crystalline resin (B) or higher is, from the viewpoint of improving the coalescing property of the aggregated particles and from the viewpoint of improving toner productivity, preferably 1 minute or more, more preferably 10 minutes or more, even more preferably 30 minutes or more, and is preferably 240 minutes or less, more preferably 180 minutes or less, even more preferably 120 minutes or less, still more preferably 90 minutes or less.

The volume median particle diameter (D₅₀) of the coalesced particles in the dispersion obtained in the step 2 is, from the viewpoint of excellent low-temperature fixing property, suppression of deterioration in low-temperature fixing property over time, and excellent heat-resistant storability, preferably 2 μm or more, more preferably 3 μm or more, even more preferably 4 μm or more, and is preferably 10 μm or less, more preferably 8 μm or less, even more preferably 6 μm or less.

The degree of circularity of the coalesced particles in the resin particle dispersion obtained in the step 2 is, from the viewpoint of excellent low-temperature fixing property, suppression of deterioration in low-temperature fixing property over time, and excellent heat-resistant storability as well as from the viewpoint of obtaining high-quality images, preferably 0.955 or more, more preferably 0.960 or more, and is preferably 0.990 or less, more preferably 0.985 or less, even more preferably 0.980 or less.

<Step 3>

The step 3 is a step of cooling the resin particle dispersion containing the amorphous resin (A) and the crystalline resin (B) obtained in the step 2, and an aqueous medium by together fluidizing and continuously mixing the resin particle dispersion and the aqueous medium to obtain a resin particle dispersion for toner.

As an apparatus for continuously mixing the resin particle dispersion containing the amorphous resin (A) and the crystalline resin (B), and the aqueous medium by fluidizing the resin particle dispersion and the aqueous medium together, it is not particularly limited as long as it is an apparatus in which, by introducing the resin particle dispersion and the aqueous medium into one apparatus, the resin particle dispersion and the aqueous medium are mixed and discharged, and the apparatus is a one having two or more inlets and one or more outlets (hereinafter also referred to as a cooling apparatus). Specifically, it is preferable to use an in-line mixer, a T-shaped pipe, a Y-shaped pipe, etc., more preferably an in-line mixer, and still more preferably a static mixer.

Since in general, the static mixer does not apply a shearing force, or even if a shearing force is applied, the shearing force is weak, it is suppressed that the resin deforms, moreover, in the case wherein the resin particles are core/shell resins, the core crystalline resin is exposed on the resin surface due to a division of the resin particles. Thus, the static mixer is suitable for producing resin particles for toner.

In addition, the static mixer is suitable for industrial production because the static mixer enables continuous processing.

Therefore, the step 3 is preferably a step of cooling the resin particle dispersion containing the amorphous resin (A) and the crystalline resin (B) obtained in the step 2, and an aqueous medium by mixing the resin particle dispersion and the aqueous medium using a static mixer to obtain a resin particle dispersion for toner.

The resin particles for toner obtained in the step 3 may be core/shell type particles having a core part and a shell part present on the surface of the core part. When the resin particles for toner are core/shell type particles, the core part contains the amorphous resin (A) and the crystalline resin (B), and the shell part contains the amorphous resin (C).

In the resin particles to be cooled (resin particles in the resin particle dispersion before cooling), the ratio by mass of the amorphous resin (A) to the crystalline resin (B) [amorphous resin (A)/crystalline resin (B)] is, from the viewpoint of heat-resistant storage stability, preferably 50/50 or more, more preferably 55/45 or more, even more preferably 60/40 or more, and is, from the viewpoint of low-temperature fixing property, preferably 95/5 or less, more preferably 90/10 or less, even more preferably 85/15 or less, still more preferably 80/20 or less.

Further, in the resin particles to be cooled (resin particles in the resin particle dispersion before cooling), the ratio by mass of the amorphous resin to the crystalline resin [amorphous resin/crystalline resin] is, from the viewpoint of heat-resistant storage stability, preferably 50/50 or more, more preferably 55/45 or more, even more preferably 60/40 or more, and is, from the viewpoint of low-temperature fixing property, preferably 95/5 or less, more preferably 90/10 or less, even more preferably 85/15 or less, still more preferably 80/20 or less. Here, the amount of the amorphous resin means a total amount when the amorphous resin (A) and the amorphous resin (C) are contained.

The static mixer preferably used in the step 3 refers to a static mixing stirrer having no moving parts. More specifically, it refers to an in-line mixer that is designed so that a purpose of mixing is achieved by the inversion and conversion of a liquid flow as the liquid advances, simply by passing the liquid through a resistance member fixed inside a pipe.

The flow characteristics of the liquid flow, that is, the mixing characteristics, can vary depending on the structure of the resistance member; however, a typical member is a rectangular plate twisted 180 degrees with left and right in opposite directions.

Such static mixers are commercially available, and representative ones are shown below.

(1) 3/4-N60S-331-0, 1/2-N60S-331-0, and 1-N30-131-F manufactured by Noritake Co., Limited

(2) SMX-DN 25×10 and SMX-DN 25×5, etc. manufactured by Sulzer Chemtech Ltd.

These static mixers generally have an inner pipe diameter of about 20 to 50 mm and a pipe length of about 20 to 50 cm.

The static mixer will be described below as an example; however, preferred conditions are the same for the cooling apparatus other than the static mixer.

A method of passing a mixture of the resin particle dispersion and the aqueous medium through the static mixer is not particularly limited; however, the mixture is fed using a pump, and the feed rate is usually about 1 to 100 kg/min, depending on the inner diameter of the pipe. Moreover, although the feeding may be repeated several times, it is preferable to feed once. That is, although the mixture may be passed through the static mixer multiple times, it is preferable to pass the mixture through the static mixer only once.

The mixing ratio of the aqueous medium to the resin particle dispersion (aqueous medium/resin particle dispersion, the ratio by mass) is, from the viewpoint of increasing the cooling rate and improving the low-temperature fixing property, preferably 1/1 or more, more preferably 1.5/1 or more, even more preferably 2/1 or more, and is, from the viewpoint of production efficiency, preferably 10/1 or less, more preferably 5/1 or less, even more preferably 3/1 or less.

The temperature of the resin particle dispersion before cooling is, from the viewpoint of low-temperature fixing property, preferably [the melting point of the crystalline resin (B)−18° C.] or higher, more preferably [the melting point of the crystalline resin (B)−15° C.] or higher, even more preferably [the melting point of the crystalline resin (B)−12° C.] or higher, and is, from the viewpoint of economy, preferably [the melting point of the crystalline resin (B)+30° C.] or lower, more preferably [the melting point of the crystalline resin (B)+20° C.] or lower, even more preferably [the melting point of the crystalline resin (B)+10° C.] or lower.

The temperature of the resin particle dispersion after cooling is, from the viewpoint of low-temperature fixing property, preferably [the melting point of the crystalline resin (B)−20° C.] or lower, more preferably [the melting point of the crystalline resin (B)−30° C.] or lower, even more preferably [the melting point of the crystalline resin (B)−40° C.] or lower, and is, from the viewpoint of work efficiency, preferably [the melting point of the crystalline resin (B)−80° C.] or higher, more preferably [the melting point of the crystalline resin (B)−60° C.] or higher, even more preferably [the melting point of the crystalline resin (B)−50° C.] or higher.

It is preferable that the temperature of the resin particle dispersion before cooling is [the melting point of the crystalline resin (B)−18° C.] or higher and the temperature of the resin particle dispersion after cooling is [the melting point of the crystalline resin (B)−20° C.] or lower, and it is preferable that the temperature of the resin particle dispersion before cooling is [the melting point of the crystalline resin (B)−15° C.] or higher and the temperature of the resin particle dispersion after cooling is [the melting point of the crystalline resin (B)−20° C.] or lower. It is more preferable that the temperature of the resin particle dispersion before cooling is [the melting point of the crystalline resin (B)−12° C.] or higher and the temperature of the resin particle dispersion after cooling is [the melting point of the crystalline resin (B)−30° C.] or lower, and it is even more preferable that the temperature of the resin particle dispersion before cooling is [the melting point of the crystalline resin (B)−12° C.] or higher and the temperature of the resin particle dispersion after cooling is [the melting point of the crystalline resin (B)−40° C.] or lower.

The cooling rate of the resin particle dispersion in the step 3 is, from the viewpoint of low-temperature fixing property, preferably 20° C./second or higher, more preferably 30° C./second or higher, even more preferably 60° C./second or higher, and is, from the viewpoint of workability and equipment load, preferably 500° C./second or lower, more preferably 300° C./second or lower, even more preferably 200° C./second or lower.

Here, the cooling rate is obtained by dividing a temperature difference between the resin particle dispersion before cooling and the resin particle dispersion after cooling by an average residence time in the static mixer.

The average residence time in the static mixer is, from the viewpoint of workability, preferably 0.1 seconds or more, more preferably 0.15 seconds or more, even more preferably 0.2 seconds or more, and is, from the viewpoint of low-temperature fixing property, preferably 3 seconds or less, more preferably 2 seconds or less, even more preferably 1 second or less.

The step of cooling is, from the viewpoint of low-temperature fixing property, a step of cooling the resin particle dispersion by preferably 20° C. or more, more preferably a step of cooling by 30° C. or more, even more preferably a step of cooling by 40° C. or more, and is, from the viewpoint of work efficiency, preferably a step of cooling by 80° C. or less, more preferably a step of cooling by 70° C. or less, and even more preferably a step of cooling by 60° C. or less.

<Post-Treatment Step>

After the step (3), a post-treatment step may be carried out, and toner particles are preferably obtained by isolation.

The resin particles in the resin particle dispersion for toner obtained in the step (3) exist in an aqueous medium, and are therefore preferably processed for solid-liquid separation. For solid-liquid separation, a suction filtration method is preferably used.

After solid-liquid separation, the particles are preferably washed. At that time, preferably, the added surfactant is also removed, and therefore for the washing, an aqueous medium is preferably used at a temperature equal to or lower than the clouding point of the surfactant. Preferably, washing is repeated plural times.

Next, drying is preferably carried out. The temperature at the time of drying is preferably such that the temperature of the toner particles themselves is lower than the glass transition temperature of the resin that constitutes the resin particles, and is more preferably such that the temperature of the toner particles themselves is lower than the minimum value of the glass transition temperature of the resin that constitutes the toner particles. As the drying method, it is preferable to use a vacuum low-temperature drying method, an oscillation-type fluidized drying method, a fluidized bed drying method, a spray drying method, a freeze drying method, a flush jet method, etc. The moisture content after drying is adjusted to preferably 1.5% by mass or less, more preferably 1.0% by mass or less, from the viewpoint of improving the charging characteristics of the toner.

[Toner for Developing Electrostatic Charge Image]

[Toner Particles]

The toner particles obtained by drying or the like can be directly used as a toner for developing an electrostatic charge image; however, t is preferable to use toner particles, the surfaces of which have been treated as described later, as the toner for developing an electrostatic charge image.

When the method of producing a resin particle dispersion for toner of the present invention includes the steps 1-1 and 1-2, the content of the crystalline resin (B) in the aggregated particles (1) obtained in the step 1-1 is, with respect to the total content of the crystalline resin (B) and the amorphous resin (A), preferably 5% by mass or more, more preferably 10% by mass or more, even more preferably 15% by mass or more, and is preferably 45% by mass or less, more preferably 40% by mass or less, even more preferably 35% by mass or less, from the viewpoint of excellent low-temperature fixing property, suppression of deterioration in low-temperature fixing property over time, and excellent heat-resistant storability.

When the method of producing a resin particle dispersion for toner of the present invention includes the steps 1-1 and 1-2, the amount of the amorphous resin (C) added in the step 1-2 is, with respect to the total amount of the crystalline resin (B) and the amorphous resin (A) contained in the aggregated particles (1) obtained in the step 1-1, preferably 3% by mass or more, more preferably 5% by mass or more, even more preferably 10% by mass or more, and is preferably 30% by mass or less, more preferably 20% by mass or less, even more preferably 15% by mass or less, from the viewpoint of excellent low-temperature fixing property, suppression of deterioration in low-temperature fixing property over time, and excellent heat-resistant storability.

In addition, the content of the crystalline resin (B) is, from the viewpoint of excellent low-temperature fixing property, suppression of deterioration in low-temperature fixing property over time, and excellent heat-resistant storability, preferably 5% by mass or more, more preferably 10% by mass or more, even more preferably 15% by mass or more, and is preferably 45% by mass or less, more preferably 40% by mass or less, even more preferably 35% by mass or less, relative to the total amount of the resin components in the toner.

The volume median particle diameter (D₅₀) of the toner particles is, from the viewpoint of improving toner productivity, from the viewpoint of improving image density of prints, and from the viewpoint of excellent low-temperature fixing property, suppression of deterioration in low-temperature fixing property over time, and excellent heat-resistant storability, preferably 2 μm or more, more preferably 3 μm or more, even more preferably 4 μm or more, and is preferably 10 μm or less, more preferably 8 μm or less, even more preferably 6 μm or less.

The CV value of the toner particles is, from the viewpoint of improving toner productivity, preferably 12% or more, more preferably 16% or more, even more preferably 20% or more, and is, from the viewpoint of giving high-quality images, preferably 30% or less, more preferably 26% or less.

The degree of circularity of the toner particles is, from the viewpoint of improving the low-temperature fixing property and charging characteristics of the toner, preferably 0.955 or more, more preferably 0.960 or more, even more preferably 0.965 or more, and is preferably 0.990 or less, more preferably 0.985 or less, even more preferably 0.980 or less.

Preferably, the toner particles further processed by adding an external additive such as a fluidity enhancer to the surfaces of the toner particles are used as a toner.

Examples of the external additive include inorganic fine particles such as hydrophobic silica, titanium oxide fine particles, alumina fine particles, cerium oxide fine particles, and carbon black, and polymer fine particles of polycarbonate, polymethyl methacrylate or silicone resin. Among these, hydrophobic silica is preferred.

In the case that a surface treatment of the toner particles is carried out with an external additive, the amount of the external additive to be added is preferably 1 part by mass or more, more preferably 2 parts by mass or more, even more preferably 3 parts by mass or more, and is preferably 5 parts by mass or less, more preferably 4.5 parts by mass or less, even more preferably 4 parts by mass or less, relative to 100 parts by mass of the toner particles.

One alone or a combination of two or more of the external additives may be used. When two or more types are used in combination, the total amount of the external additives to be added is preferably the above amount.

The toner for developing an electrostatic charge image obtained according to the present invention can be used as a one-component developing agent, or as a two-component developing agent as mixed with a carrier.

The present invention further discloses the following [1] to [29].

[1] A method of producing a resin particle dispersion for toner, comprising

a step of cooling a resin particle dispersion containing an amorphous resin and a crystalline resin, and an aqueous medium by together fluidizing and continuously mixing the resin particle dispersion and the aqueous medium.

[2] The method of producing a resin particle dispersion for toner according to [1], wherein the step of cooling is a step of continuously mixing the resin particle dispersion and the aqueous medium using a static mixer.

[3] The method of producing a resin particle dispersion for toner according to [2], wherein an average residence time in the static mixer is 3 seconds or less.

[4] The method of producing a resin particle dispersion for toner according to [2] or [3], wherein the average residence time in the static mixer is 0.1 seconds or more and 3 seconds or less.

[5] The method of producing a resin particle dispersion for toner according to any one of [2] to [4], wherein the average residence time in the static mixer is 0.1 seconds or more and 2 seconds or less.

[6] The method of producing a resin particle dispersion for toner according to any one of [2] to [5], wherein the average residence time in the static mixer is 0.15 seconds or more and 2 seconds or less.

[7] The method of producing a resin particle dispersion for toner according to any one of [1] to [6], wherein a cooling rate of the step of cooling is 20° C./second or more.

[8] The method of producing a resin particle dispersion for toner according to any one of [1] to [7], wherein the cooling rate of the step of cooling is 20° C./second or more and 500° C./second or less.

[9] The method of producing a resin particle dispersion for toner according to any one of [1] to [8], wherein the cooling rate of the step of cooling is 30° C./second or more and 300° C./second or less.

[10] The method of producing a resin particle dispersion for toner according to any one of [1] to [9], wherein the cooling rate of the step of cooling is 60° C./second or more and 200° C./second or less.

[11] The method of producing a resin particle dispersion for toner according to any one of [1] to [10], wherein the step of cooling is a step of cooling the resin particle dispersion by 20° C. or more.

[12] The method of producing a resin particle dispersion for toner according to any one of [1] to [11], wherein the step of cooling is a step of cooling the resin particle dispersion by 20° C. or more and 80° C. or less.

[13] The method of producing a resin particle dispersion for toner according to any one of [1] to [12], wherein the step of cooling is a step of cooling the resin particle dispersion by 30° C. or more and 80° C. or less.

[14] The method of producing a resin particle dispersion for toner according to any one of [1] to [13], wherein the step of cooling is a step of cooling the resin particle dispersion by 40° C. or more and 70° C. or less.

[15] The method of producing a resin particle dispersion for toner according to any one of [1] to [14], wherein the resin particle dispersion before cooling has a temperature of [a melting point of the crystalline resin−18° C.] or higher, and the resin particle dispersion after cooling has a temperature of [the melting point of the crystalline resin−20° C.] or lower.

[16] The method of producing a resin particle dispersion for toner according to any one of [1] to [15], wherein the temperature of the resin particle dispersion before cooling is [the melting point of the crystalline resin−18° C.] or higher, and [the melting point of the crystalline resin+30° C.] or lower.

[17] The method of producing a resin particle dispersion for toner according to any one of [1] to [16], wherein the temperature of the resin particle dispersion before cooling is [the melting point of the crystalline resin−15° C.] or higher and [the melting point of the crystalline resin+30° C.] or lower.

[18] The method of producing a resin particle dispersion for toner according to any one of [1] to [17], wherein the temperature of the resin particle dispersion before cooling is [the melting point of the crystalline resin−15° C.] or higher and [the melting point of the crystalline resin+20° C.] or lower.

[19] The method of producing a resin particle dispersion for toner according to any one of [1] to [18], wherein the temperature of the resin particle dispersion after cooling is [the melting point of the crystalline resin−80° C.] or higher and [the melting point of the crystalline resin−20° C.] or lower.

[20] The method of producing a resin particle dispersion for toner according to any one of [1] to [19], wherein the temperature of the resin particle dispersion after cooling is [the melting point of the crystalline resin−80° C.] or higher and [the melting point of the crystalline resin−30° C.] or lower.

[21] The method of producing a resin particle dispersion for toner according to any one of [1] to [20], wherein the temperature of the resin particle dispersion after cooling is [the melting point of the crystalline resin−60° C.] or higher and [the melting point of the crystalline resin−30° C.] or lower.

[22] The method of producing a resin particle dispersion for toner according to any one of [1] to [21], wherein a mixing ratio of the aqueous medium to the resin particle dispersion (aqueous medium/resin particle dispersion) is 1/1 or more and 10/1 or less.

[23] The method of producing a resin particle dispersion for toner according to any one of [1] to [22], wherein the mixing ratio of the aqueous medium to the resin particle dispersion (aqueous medium/resin particle dispersion) is 1.5/1 or more and 10/1 or less.

[24] The method of producing a resin particle dispersion for toner according to any one of [1] to [23], wherein the mixing ratio of the aqueous medium to the resin particle dispersion (aqueous medium/resin particle dispersion) is 1.5/1 or more and 5/1 or less.

[25] The method of producing a resin particle dispersion for toner according to any one of [1] to [24], wherein, in resin particles to be cooled (the resin particles in the resin particle dispersion before cooling), a mass ratio of the amorphous resin to the crystalline resin [amorphous resin/crystalline resin] is 50/50 or more and 95/5 or less.

[26] The method of producing a resin particle dispersion for toner according to any one of [1] to [25], wherein, in the resin particles to be cooled (the resin particles in the resin particle dispersion before cooling), the mass ratio of the amorphous resin to the crystalline resin [amorphous resin/crystalline resin] is 55/45 or more and 90/10 or less.

[27] The method of producing a resin particle dispersion for toner according to any one of [1] to [26], wherein, in the resin particles to be cooled (the resin particles in the resin particle dispersion before cooling), the mass ratio of the amorphous resin to the crystalline resin [amorphous resin/crystalline resin] is 60/40 or more and 85/15 or less.

[28] The method of producing a resin particle dispersion for toner according to any one of [1] to [27], wherein the resin particle dispersion before cooling is a dispersion of coalesced particles obtained by a step of aggregating the amorphous resin and the crystalline resin in the aqueous medium to obtain a dispersion of aggregated particles (step 1) and a step of heat-coalescing the obtained aggregated particles in the aqueous medium to obtain a dispersion of coalesced particles (step 2).

[29] A method of producing a toner for developing an electrostatic charge image, comprising the production method according to any one of [1] to [28].

### EXAMPLES

Property values were measured according to the methods mentioned below. Various evaluations were made according to the methods mentioned below.

[Measurement]

[Acid Value and Hydroxyl Value of Resin and Wax]

The acid value and the hydroxyl value of resin and wax were measured according to a neutralization titration method described in JIS K 0070:1992. However, the solvent in measurement was changed to chloroform.

[Softening Point, Crystallinity Index, Melting Point and Glass Transition Temperature of Resin]

(1) Softening Point

Using a flow tester “CFT-500D” (from Shimadzu Corporation), 1 g of a sample was extruded through a nozzle having a die pore diameter of 1 mm and a length of 1 mm while heating the sample at a heating rate of 6° C./min and applying a load of 1.96 MPa thereto by a plunger. The softening point was determined as the temperature at which a half amount of the sample was flowed out when plotting a downward movement of the plunger of the flow tester relative to the temperature.

(2) Crystallinity Index

Using a differential scanning calorimeter “Q100” (from TA Instruments Japan Inc.), 0.02 g of a sample was weighed in an aluminum pan and cooled down from room temperature (20° C.) to 0° C. at a cooling rate of 10° C./min. Next, the sample was kept as such for 1 minute, and thereafter heated up to 180° C. at a heating rate of 10° C./min to measure the quantity of heat thereof. Among the detected endothermic peaks, a peak temperature at which the peak area is the largest is referred to as a maximum peak temperature (1), and according to (softening point (° C.))/(endothermic maximum peak temperature (1) (° C.)), the crystallinity index was determined.

(3) Melting Point and Glass Transition Temperature

Using a differential scanning calorimeter “Q100” (from TA Instruments Japan Inc.), 0.02 g of a sample was weighed in an aluminum pan, heated up to 200° C., and then cooled from the temperature down to 0° C. at a cooling rate of 10° C./min. Next, the sample was heated at a heating rate of 10° C./min to measure the quantity of heat thereof. Among the detected endothermic peaks, a peak temperature at which the peak area is the largest is referred to as an endothermic maximum peak temperature (2). In the case of a crystalline resin, the peak temperature is referred to as the melting point thereof.

In the case of an amorphous resin that gave a peak, the peak temperature is the glass transition temperature thereof, but in the case where the amorphous resin did not give a peak but showed step, a temperature at the intersection point between a tangent line that shows a maximum inclination of a curve of the step part and an extension line of a base line on a low temperature side of the step is referred to as a glass transition temperature of the resin.

[Melting Point of Wax]

Using a differential scanning calorimeter “Q100” (from TA Instruments Japan Inc.), 0.02 g of a sample was weighed in an aluminum pan, heated up to 200° C., and then cooled from 200° C. down to 0° C. at a cooling rate of 10° C./min. Next, the sample was heated at a heating rate of 10° C./min to measure the quantity of heat thereof, and the endothermic maximum peak temperature is referred to as the melting point of the sample.

[Number Average Molecular Weight (Mn) of Wax]

The number average molecular weight (Mn) was measured by a gel permeation chromatography (GPC) method shown below.

(1) Preparation of Sample Solution

A sample was dissolved in chloroform at 25° C. to give a concentration of 0.5 g/100 mL, and then the solution was filtered using a fluororesin filter “DISMIC, 25JP” (manufactured by ADVANTEC Corporation) with a pore size of 0.2 μm to remove insoluble components to obtain a sample solution.

(2) Measurement

Using the following measuring apparatus and analysis column, chloroform was flowed as an eluent at a flow rate of 1 mL/min, the column was stabilized in a constant temperature bath at 40° C., and 100 μL of the sample solution was injected therein to measure the molecular weight. The molecular weight (number average molecular weight Mn) of the sample was calculated based on a previously prepared calibration curve using, as standard samples, several types of monodisperse polystyrene “TSKgel standard polystyrene” with the following type names (Mw): “A-500 (5.0×10²)”, “A-1000 (1.01×10³)”, “A-2500 (2.63×10³)”, “A-5000 (5.97×10³)”, “F-1 (1.02×10⁴)”, “F-2 (1.81×10⁴)”, “F-4 (3.97×10⁴)”, “F-10 (9.64×10⁴)”, “F-20 (1.90×10⁵)”, “F-40 (4.27×10⁵)”, “F-80 (7.06×10⁵)”, “F-128 (1.09×10⁶)” (all from Tosoh Corporation).
Measuring Apparatus: “HLC-8220GPC” (from Tosoh Corporation)
Analysis Columns: “GMHXL” and “G3000HXL” (all from Tosoh Corporation)

[Volume Median Particle Diameter (D₅₀) and CV Value of Resin Particles, Colorant Particles and Wax Particles]

(1) Measuring Apparatus: Laser diffraction particle size analyzer “LA-920” (from HORIBA Ltd.)
(2) Measuring Conditions: In a cell for the measurement, distilled water was added thereto, and at a concentration at which the absorbance could fall within an appropriate range, the volume median particle diameter (D₅₀) and the volume-average particle size of a sample were measured. A relative refractive index was set to 1.10, a circulation pump was set ON, and a circulation speed was set to 5. The CV value was calculated according to the following expression.

CV value (%)=(standard deviation of particle size distribution/volume−average particle size)×100

[Solid Concentration in Resin Particle Dispersion, Colorant Particle Dispersion and Wax Particle Dispersion]

Using an infrared moisture meter “FD-230” (from Kett Electric Laboratory), 5 g of a sample to be measured was dried at a drying temperature of 150° C. under a measuring mode 96 (monitoring time: 2.5 minutes, moisture variation range: 0.05%), and then subjected to measurement of a water content (% by mass) of the sample. The solid concentration was calculated according to the following expression.

Solid concentration (% by mass)=100−water content (% by mass)

[Volume Median Particle Diameter (D₅₀) of Aggregated Particles]

(1) Measuring Apparatus: “Coulter Multisizer (trademark) III” (from Beckman Coulter Inc.)
(2) Analyzing Software: “Multisizer (trademark) III version 3.51” (from Beckman Coulter Inc.)
(3) Measuring conditions:
Electrolyte Solution: “Isotone (trademark) II” (from Beckman Coulter Inc.)
Aperture Diameter: 50 μm

A sample dispersion was added to 100 mL of the above-mentioned electrolyte solution to control the concentration thereof so as to complete the measurement for particle sizes of 30,000 particles within 20 seconds, then the particle sizes of the 30,000 particles in the dispersion were measured, and the volume median particle diameter (D₅₀) of the particles was determined from the particle size distribution thereof.

[Low-Temperature Fixing Property of Toner]

Using a commercially-available printer “Microline (trademark) 5400” (from Oki Data Corporation), a solid image was outputted but not fixed on high-quality paper “J Paper A4 Size” (from Fuji Xerox Corporation) in such a manner that the toner deposition amount on the paper could be 0.45±0.03 mg/cm² in a length of 50 mm with a blank space of 5 mm from the top of the A4 paper left to remain as such.

Next, the same printer in which the fixing device had been modified to be applicable to a varying temperature was prepared, then the temperature of the fixing device was set at 90° C., and the toner was fixed at a speed of 1.5 seconds to give prints.

In the same manner but the temperature of the fixing device was elevated at intervals of 5° C., the toner was fixed also to give prints.

From the blank space at the top of the image to the solid image on the print, a mending tape “Scotch (trademark) Mending Tape 810” (from Sumitomo 3M Corporation, width 18 mm) cut in a size of 50 mm was lightly adhered to the print, then a columnar weight of 500 g (shape: cylinder, bottom area 1963 cm²) was put on it, and pressed for one back-and-forth movement at a speed of 10 mm/s. Subsequently, the adhered tape was peeled from the bottom side at a peeling angle of 180° and at a speed of 10 mm/s to give a tape-peeled print. 30 sheets of high-quality paper “Excellent White Paper A4 Size” (from Oki Data Corporation) were laid below the print before the tape was adhered and after the tape was peeled, and the reflection image density of the fixed image part of each print before tape adhesion and after tape peeling was measured using a colorimeter “Spectro Eye” (from Gretag Macbeth Corporation, light incidence condition: standard light source D50, observation viewing field 2°, density standard DINNB, absolute white standard). From the reflection image density, the fixation ratio was calculated according to the following expression.

Fixation Ratio (%)=(reflection image density after tape peeling/reflection image density before tape adhering)×100

The temperature at which the fixation ratio is 90% or more is referred to as a lowest fixing temperature. The lower the lowest fixing temperature, the better the low-temperature fixing property.

[Production of Resin]

### Production Example A1 (Production of Amorphous Resin A-1)

The inside of a four-neck flask having an internal volume of 20 L and equipped with a nitrogen inlet tube, a dewatering tube, a stirrer and a thermocouple was purged with nitrogen, and 6,536 g of polyoxypropylene (2.2) adduct of bisphenol A, 2,170 g of terephthalic acid, 60 g of tin(II) di(2-ethylhexanoate), 6 g of 3,4,5-trihydroxybenzoic acid, and 788 g of hydrocarbon wax W1 “Paracol 6490” (from Nippon Seiro Co., Ltd.) were put thereinto, and heated up to 235° C. with stirring in a nitrogen atmosphere, then kept at 235° C. for 8 hours, and the pressure inside the flask was lowered, and was kept at 8 kPa for 1 hour. Subsequently, the flask was restored to an atmospheric pressure, then cooled down to 155° C., and while kept at 155° C., a mixture of 4,276 g of styrene, 1,068 g of stearyl methacrylate, 216 g of acrylic acid and 642 g of dibutyl peroxide was dropwise added thereto taking 3 hours. Subsequently, this was kept at 155° C. for 30 minutes, then heated up to 200° C., and the pressure inside the flask was further lowered and kept at 8 kPa for 1 hour. Subsequently, this was restored to an atmospheric pressure, cooled down to 190° C., then 140 g of fumaric acid, 538 g of trimellitic anhydride and 5.0 g of 4-tert-butylcatechol were added, then heated up to 210° C. at a rate of 10° C./hr, and thereafter reacted at 8 kPa to a desired softening point to give an amorphous resin A-1. The properties are shown in Table 1.

### Production Example A2 (Production of Amorphous Resin A-2)

The inside of a four-neck flask having an internal volume of 10 L and equipped with a nitrogen inlet tube, a dewatering tube, a stirrer and a thermocouple was purged with nitrogen, and 4,313 g of polyoxypropylene (2.2) adduct of bisphenol A, 818 g of terephthalic acid, 727 g of succinic acid, 30 g of tin(II) di(2-ethylhexanoate), and 3.0 g of 3,4,5-trihydroxybenzoic acid were put thereinto, and heated up to 235° C. with stirring in a nitrogen atmosphere, then kept at 235° C. for 5 hours, and the pressure inside the flask was lowered, and was kept at 8 kPa for 1 hour. Subsequently, the flask was restored to an atmospheric pressure, then cooled down to 160° C., and while kept at 160° C., a mixture of 2,756 g of styrene, 689 g of stearyl methacrylate, 142 g of acrylic acid, and 413 g of dibutyl peroxide was dropwise added thereto taking 1 hour. Subsequently, this was kept at 160° C. for 30 minutes, then heated up to 200° C., and thereafter the pressure inside the flask was lowered, and these were reacted at 8 kPa to a desired softening point to give an amorphous resin A-2. The properties are shown in Table 1.

### Production Example C1 (Production of Amorphous Resin C-1)

The inside of a four-neck flask having an internal volume of 10 L and equipped with a nitrogen inlet tube, a dewatering tube, a stirrer and a thermocouple was purged with nitrogen, and 5,363 g of ethylene oxide (2.2) adduct of bisphenol A, 1,780 g of terephthalic acid, 40 g of tin(II) di(2-ethylhexanoate), and 4 g of 3,4,5-trihydroxybenzoic acid were put thereinto, and heated up to 235° C. with stirring in a nitrogen atmosphere, then kept at 235° C. for 8 hours, and the pressure inside the flask was lowered, and was kept at 8 kPa for 1 hour. Subsequently, the flask was restored to an atmospheric pressure, then cooled down to 180° C., 287 g of fumaric acid, 221 g of dodecenylsuccinic anhydride, 380 g of trimellitic anhydride, and 2.5 g of 4-tert-butylcatechol were added, then heated up to 220° C. at a rate of 10° C./hr, and thereafter the pressure inside the flask was lowered, and these were reacted at 10 kPa to a desired softening point to give an amorphous resin C-1. The properties of the resin were measured and are shown in Table 1.

TABLE 1

| | | | Production | | Production | | Production | |
|---|---|---|---|---|---|---|---|---|
| | | | Example A1 | | Example A2 | | Example C1 | |
| Amorphous resin A | | | A-1 | | A-2 | | C-1 | |
| | | | charged | part by | charged | part by | charged | part by |
| | | | amount (g) | mol *2 | amount (g) | mol *2 | amount (g) | mol *2 |
| Raw material monomer P | Alcohol component | BPA-PO *1 | 6536 | 100 | 4313 | 100 | 5363 | 100 |
| for polyester resin | Carboxylic acid | Terephthalic acid | 2170 | 70 | 818 | 40 | 1780 | 70 |
| segment | component | Fumaric acid | 140 | 6.5 | — | — | 287 | 16 |
| | | Succinic acid | — | — | 727 | 50 | — | — |
| | | Dodecenyl succinic | — | — | — | — | 221 | 5 |
| | | anhydride | | | | | | |
| | | Trimellitic anhydride | 538 | 15 | — | — | 380 | 13 |

| Bireactive monomer | Acrylic acid | 216 | 16 | 142 | 16 | | |
|---|---|---|---|---|---|---|---|
| | | charged | % by | charged | % by | charged | % by |
| | | amount (g) | mass *3 | amount (g) | mass *3 | amount (g) | mass *3 |
| Raw material monomer V | Styrene | 4276 | 80 | 2756 | 80 | — | — |
| for addition | Stearyl methacrylate | 1068 | 20 | 689 | 20 | — | — |
| polymerization resin | | | | | | | |
| segment | | | | | | | |

| Hydrocarbon wax W1 | Paracol 6490 (g) *5 | 788 | — | — |
|---|---|---|---|---|
| having hydroxy group or | | | | |
| carboxy group | | | | |
| Esterification catalyst | Tin(II) di(2-ethylhexanoate) (g) | 60 | 30 | 40 |
| Esterification promoter | 3,4,5-trihydroxybenzoic acid (g) | 6.0 | 3.0 | 4.0 |
| Radical polymerization | Dibutyl peroxide (g) | 642 | 413 | — |
| initiator | | | | |
| Radical polymerization | 4-tert-butylcatechol (g) | 5.0 | — | 2.5 |
| inhibitor | | | | |
| Amount of addition polymerization resin segment in amorphous resin A (% | | 37 | 39 | 0 |
| by mass) *4 | | | | |
| Amount of component derived from hydrocarbon wax W1 (% by mass) | | 5 | 0 | 0 |
| Properties | Softening Point (° C.) | 122 | 91 | 112 |
| | Glass Transition Temperature (° C.) | 61 | 42 | 63 |
| | Crystallinity Index | 1.8 | 1.8 | 1.7 |
| | Acid Value (mgKOH/g) | 21 | 24 | 20 |

*1: BPA-PO means polyoxypropylene (2.2) adduct of bisphenol A. The numeric value in parentheses means that the average molar number of addition is 2.2.
*2: This means part by mol of each monomer constituting the raw material monomer P and the bireactive monomer, based on the alcohol component of the raw material monomer P as 100 parts by mol.
*3: This means a content (% by mass) of each monomer constituting the raw material monomer (V) in the total amount of the raw material monomer V.
*4: This is calculated based on the ratio of amounts of the raw material monomers, the hydrocarbon wax W1, the bireactive monomer, and the radical polymerization initiator without considering the dehydration amount due to polycondensation. The mass of the radical polymerization initiator is calculated included in the addition polymerization resin segment.
*5: Paracol 6490: from Nippon Seiro Co., Ltd., Mn 800, melting point 76° C., acid value 18 mgKOH/g, hydroxyl value 97 mgKOH/g

### Production Example B1 (Production of Crystalline Resin B-1)

The inside of a four-neck flask having an internal volume of 10 L and equipped with a nitrogen inlet tube, a dewatering tube, a stirrer and a thermocouple was purged with nitrogen, and 3,416 g of 1,10-decanediol and 4,084 g of sebacic acid were added, and heated up to 135° C. with stirring, then kept at 135° C. for 3 hours, and then heated from 135° C. to 200° C. taking 10 hours. Subsequently, 23 g of tin (II) di(2-ethylhexanoate) was added, further kept at 200° C. for 1 hour, and thereafter the pressure inside the flask was lowered, and these were kept under a reduced pressure of 8 kPa for 1 hour to give a crystalline resin B-1. The properties are shown in Table 2.

TABLE 2

| | | | Production Example B1 | |
|---|---|---|---|---|
| | | | B-1 | |
| | | | charged | part by |
| Crystalline resin B | | | amount (g) | mol *1 |
| Raw material | alcohol | 1,10- | 3416 | 100 |
| monomer | component | decanediol | | |
| | carboxylic acid | sebacic acid | 4084 | 103 |
| | component | | | |

| | | |
|---|---|---|
| Esterification | tin(II) di(2-ethylhexanoate) (g) | 23 |
| catalyst | | |
| Properties | Softening Point (° C.) | 88 |
| | Melting point (° C.) | 77 |
| | Crystallinity Index | 1.1 |
| | Acid Value (mgKOH/g) | 17 |

*1: This means part by mol of each monomer constituting the raw material monomers when the alcohol component of the raw material monomer is taken as 100 parts by mol.

[Production of Resin Particle Dispersion]

### Production Example X1 (Production of Resin Particle Dispersion X-1)

12,600 g of the amorphous resin A-1, 5,400 g of the crystalline resin B-1, and 18,000 g of methyl ethyl ketone were put into a reactor having an internal volume of 100 L and equipped with a stirrer, a cooler, a thermometer, and a nitrogen inlet tube, and were stirred at 73° C. for 4 hours to dissolve the resins. An aqueous solution of 5 mass % sodium hydroxide was added to the resultant solution so that the degree of neutralization could be 50 mol % relative to the acid value of the resins, and stirred for 30 minutes.

Next, while kept at 73° C. and stirring, 36,000 g of deionized water was added taking 60 minutes for transfer-phase emulsification. Still continuously kept at 73° C., methyl ethyl ketone was evaporated away under reduced pressure to give an aqueous dispersion. Subsequently, with stirring, the aqueous dispersion was cooled to 30° C., and then deionized water was added to have a solid concentration of 35% by mass, followed by filtration of the mixture through a 150-mesh wire mesh, thereby preparing a resin particle dispersion X-1. The volume median particle diameter (D₅₀) and the CV value of the resultant resin particles are shown in Table 3.

TABLE 3

| Production Example | Production Example X1 |
|---|---|
| Resin particle dispersion | X-1 |
| Amorphous resin (A) | A-1 |
| Crystalline resin (B) | B-1 |
| (A)/(B) | 70/30 |
| Volume median particle diameter D₅₀ (μm) | 0.18 |
| CV value (%) | 23 |

### Production Example Y1

### Production of Resin Particle Dispersion Y-1

2,000 g of the amorphous resin C-1 and 2,000 g of methyl ethyl ketone were put into a container having an internal volume of 10 L and equipped with a stirrer, a reflux condenser, a dropping funnel, a thermometer and a nitrogen inlet tube, and the resin was dissolved at 73° C. taking 3 hours. An aqueous solution of 5 mass % sodium hydroxide was added to the resultant solution so that the degree of neutralization could be 60 mol % relative to the acid value of the amorphous resin C-1, and stirred for 30 minutes. Next, while kept at 73° C. and stirring at 250 r/min, 4,000 g of deionized water was added taking 60 minutes for transfer-phase emulsification. Still continuously kept at 73° C., methyl ethyl ketone was evaporated away under reduced pressure to give an aqueous dispersion. Subsequently, with stirring at 200 r/min, the aqueous dispersion was cooled to 30° C., and then deionized water was added to have a solid concentration of 35% by mass, followed by filtration of the mixture through a 150-mesh wire mesh, thereby preparing a resin particle dispersion Y-1. The volume median particle diameter (D₅₀) of the resultant resin particles was 0.11 μm, and the CV value of the resultant resin particles was 23%.

### Production Example Z1

### Production of Resin Particle Dispersion Z-1

1,200 g of the amorphous resin A-2 and 1,200 g of methyl ethyl ketone were put into a container having an internal volume of 10 L and equipped with a stirrer, a reflux condenser, a dropping funnel, a thermometer and a nitrogen inlet tube, and the resin was dissolved at 73° C. taking 2 hours. An aqueous solution of 5 mass % sodium hydroxide was added to the resultant solution so that the degree of neutralization could be 60 mol % relative to the acid value of the amorphous resin A-2, and stirred for 60 minutes.

Next, while kept at 73° C. and stirring at 250 r/min (peripheral speed 79 m/min), 2,400 g of deionized water was added taking 60 minutes for transfer-phase emulsification. Still continuously kept at 73° C., methyl ethyl ketone was evaporated away under reduced pressure to give an aqueous dispersion. Subsequently, with stirring at 280 r/min (peripheral speed 88 m/min), the aqueous dispersion was cooled to 30° C., and then deionized water was added to have a solid concentration of 35% by mass, followed by filtration of the mixture through a 150-mesh wire mesh, thereby preparing a resin particle dispersion Z-1. The volume median particle diameter (D₅₀) of the resultant resin particles was 0.09 μm, and the CV value of the resultant resin particles was 23%.

### Production of Wax Particle Dispersion

### Production Example D1 (Production of Wax Particle Dispersion D-1)

7,572 g of deionized water, 3,429 g of the resin particle dispersion Z-1 and 3,000 g of paraffin wax “HNP-9” (from Nippon Seiro Co., Ltd., melting point: 75° C.) were added to a stainless container having an internal volume of 30 L, and melted while kept at a temperature of 90 to 95° C., then stirred to give a molten mixture. While further kept at a temperature of 90 to 95° C., the resultant molten mixture was dispersed for 120 minutes at 40 MPa, using a pressure discharge homogenizer (Gaulin Homogenizer, from Gaulin Corporation), and then cooled down to room temperature. Deionized water was added to make the solid concentration 30% by mass to give a wax particle dispersion D-1. The volume median particle diameter D₅₀ and the CV value of the wax particles in the dispersion are shown in Table 4.

TABLE 4

| Production Example | Production Example D1 |
|---|---|
| Wax particle dispersion | D-1 |
| Wax | HNP-9 *1 |
| Melting point of wax (° C.) | 75 |
| Resin particle dispersion | Z-1 |
| Volume median particle diameter D₅₀(μm) | 0.47 |
| CV value (%) | 27 |

*1: HNP-9; paraffin wax (from Nippon Seiro Co., Ltd.)

### Production of Colorant Particle Dispersion

### Production Example P1 (Production of Colorant Particle Dispersion P-1)

In a stainless container having an internal volume of 10 L, 2,400 g of a cyan pigment “ECB-301” (copper phthalocyanine pigment, from Dainichiseika Color & Chem MFG Co., Ltd.), 960 g of polyoxyethylene (13) distyrenated phenyl ether “Emulgen A-60” (from Kao Corporation, nonionic surfactant, average molar number of addition of polyoxyethylene is 13), and 4,800 g of deionized water were mixed, and, using a homomixer “T.K. AGI HOMOMIXER 2M-03” (from PRIMIX Corporation), the mixture was dispersed at room temperature with a stirring blade rotating speed of 8,000 rpm for 1 hour. Then, the mixture was subjected to 15PASS treatment at a pressure of 150 MPa using “Microfluidizer M-7115” (from Microfluidics), followed by filtration of the mixture through a 200-mesh filter, and deionized water was added thereto such that the solid concentration was 30% by mass to obtain a colorant particle dispersion P-1. The volume median particle diameter (D₅₀) of the resultant colorant particles was 0.18 μm, and the CV value of the resultant colorant particles was 25%.

### Example 1

(Aggregating and Coalescing Step)

In a 45° inclined paddle blade (blade diameter 0.35 m) of a spherical bottom cylindrical tank (inner diameter 0.7 m) having an internal volume of 300 L equipped with a stirrer and hot water jacket, 26.03 kg of the resin particle dispersion X-1, 10.44 kg of the wax particle dispersion D-1, 5.30 kg of the colorant particle dispersion P-1, 0.93 kg of an aqueous 10 mass % solution of Emulgen 150 (from Kao Corporation, polyoxyethylene lauryl ether), 1.24 kg of Neopelex G-15 (from Kao Corporation, sodium dodecylbenzenesulfonate), and 21.19 kg of deionized water were mixed for 5 minutes at a temperature of 25° C. and a stirring rotation speed of 40 r/min. Next, with stirring the mixture, a solution prepared by adding 2.72 kg of an aqueous 4.8 mass % solution of potassium hydroxide to an aqueous solution prepared by dissolving 3.20 kg of ammonium sulfate in 46.46 kg of deionized water to adjust pH of the mixture to 8.6 was dropwise added to the mixture at 25° C. taking 30 minutes. Then the stirring rotation speed was increased to 92 r/min, the mixture was heated up to 62° C. taking 2 hours, and kept at 62° C. until the volume median particle diameter of the aggregated particles could reach 5.2 μm to prepare a dispersion of aggregated particles (1).

The dispersion of the aggregated particles (1) was cooled to 53° C. taking 30 minutes, and while being kept at 53° C., 3.15 kg of the resin particle dispersion Y-1 and 1.69 kg of deionized water were dropwise added taking 1 hour to prepare a dispersion of aggregated particles (2).

An aqueous solution prepared by mixing 20.75 kg of an anionic surfactant “Emal (trademark) E-27C” (from Kao Corporation, sodium polyoxyethylene lauryl ether sulfate, effective concentration 27% by mass), 35.27 kg of deionized water, and 3.12 kg of 0.1 mol/L sulfuric acid was added to the dispersion of the aggregated particles (2). Subsequently, this was heated up to 75° C. taking 1 hour, then 7.75 kg of a 0.1 mol/L sulfuric acid was added and the mixture was kept at 75° C. until the particles could have a degree of circularity of 0.963 and a volume median particle diameter of 4.9 μm, thereby preparing a dispersion (3) of resin particles for toner formed through coalescing of the aggregated particles.

(Cooling Step)

In a drum having an internal volume of 200 L, 124.4 kg of deionized water was added and cooled to 7.7° C. 124.4 kg of the cooled deionized water was transferred at a speed of 2.43 kg/min to, and 55.3 kg of the dispersion (3) of the coalesced toner particles was transferred at a speed of 1.08 kg/min to a static mixer (model 1/4-N30-232-F, from Noritake Co., Ltd.) and mixed, and the dispersion of the resin particles for toner was cooled to 27° C. The coalesced resin particles for toner were cooled in a pipe during transfer, and the temperature at an inlet of the static mixer was 71° C.

The number of elements of the static mixer used was 12, the inner diameter of the pipe was 10.5 mm, and the length was 200 mm. In addition, the residence time in the static mixer used was 0.3 seconds.

(Filtration Drying Step)

The cooled dispersion of resin particles for toner was filtered by suction to separate the solid fraction, and the solid fraction was washed with deionized water at 25° C. and filtered through suction filtration at 25° C. for 2 hours. Subsequently, using a vacuum low-temperature drier (DRV622DA, from ADVANTEC Corporation), this was dried in vacuum at 33° C. for 48 hours to give toner particles (4).

(External Adding Step)

100 parts by mass of the toner particles (4), 2.5 parts by mass of hydrophobic silica “RY50” (from Nippon Aerosil Co., Ltd., number-average particle size: 0.04 μm) and 1.0 part by mass of hydrophobic silica “Cabosil (trademark) TS720” (from Cabot Japan Co., Ltd., number-average particle size: 0.012 μm) were put into a Henschel mixer and stirred, then filtered through a 150-mesh sieve to give a toner 1. Evaluation results of the obtained toner 1 are shown in Table 5.

### Example 2

Toner 2 was obtained in the same manner as in Example 1, except that the cooling step was changed as follows. Evaluation results of the obtained toner 2 are shown in Table 5.

(Cooling Step)

In a stainless steel barrel having an internal volume of 50 L, 16.3 kg of deionized water was added and cooled to 10.6° C. 16.3 kg of the cooled deionized water was transferred at a speed of 1.42 kg/min to, and 7.2 kg of the dispersion (3) of the coalesced toner particles was transferred at a speed of 0.63 kg/min to a static mixer (model 1/4-N30-232-F, from Noritake Co., Ltd.) and mixed, and the dispersion of the resin particles for toner was cooled to 26.3° C. The coalesced resin particles for toner were cooled in a pipe during transfer, and the temperature at an inlet of the static mixer was 65.2° C.

The number of elements of the static mixer used was 12, the inner diameter of the pipe was 10.5 mm, and the length was 200 mm. In addition, the residence time in the static mixer used was 0.5 seconds.

### Example 3

Toner 3 was obtained in the same manner as in Example 2, except that the filtration drying step was changed as follows. Evaluation results of the obtained toner 3 are shown in Table 5.

(Filtration Drying Step)

The cooled dispersion of resin particles for toner was transferred to a filter press (PF-7C, from Nihon Rokasochi Co., Ltd.), pressed to separate the solid content, and then the solid content was washed with deionized water at 25° C. Subsequently, using an air stream dryer (FJD-4 from Seishin Enterprise Co., Ltd.), this was dried at an inlet air volume of 10 m³/min, an inlet temperature of 43° C. and an outlet temperature of 37° C. to prepare toner particles (3).

### Example 4

Toner 4 was obtained in the same manner as in Example 3, except that the cooling step was changed as follows. Evaluation results of the obtained toner 4 are shown in Table 5.

(Cooling Step)

In a stainless steel barrel having an internal volume of 50 L, 26.1 kg of deionized water was added and cooled to 20.7° C. 26.1 kg of the cooled deionized water was transferred at a speed of 2.90 kg/min to, and 5.6 kg of the dispersion (3) of the coalesced toner particles was transferred at a speed of 0.62 kg/min to a static mixer (model 1/4-N30-232-F, from Noritake Co., Ltd.) and mixed, and the dispersion of the resin particles for toner was cooled to 27.4° C. The coalesced resin particles for toner were cooled in a pipe during transfer, and the temperature at an inlet of the static mixer was 63.5° C.

The number of elements of the static mixer used was 12, the inner diameter of the pipe was 10.5 mm, and the length was 200 mm. In addition, the residence time in the static mixer used was 0.3 seconds.

### Comparative Example 1

Toner 5 was obtained in the same manner as in Example 1, except that the cooling step was changed as follows. Evaluation results of the obtained toner 5 are shown in Table 5.

(Cooling Step)

In a container having an internal volume of 20 L, 6.8 kg of deionized water was added and cooled to 7.7° C. While stirring the cooled deionized water, 3.0 kg of the dispersion (3) of the toner resin particles coalesced at 71° C. was added to the cooled deionized water at a speed of 18 kg/min for 10 seconds and stirred, and the toner particle dispersion was cooled to 27° C. In Comparative Example 1, the transfer time for mixing was 10 seconds, the stirring time after mixing was 10 seconds, and the processing time (residence time) was 20 seconds.

### Reference Example 1

Toner 6 was obtained in the same manner as in Example 2, except that the drying step was changed as follows. Evaluation results of the obtained toner 6 are shown in Table 5.

(Drying Step)

Using a fluidized bed dryer (AGM-2PJ, from Hosokawa Micron Corporation), drying was performed for 1 hour at an inlet air volume of 0.75 m³/min and an internal temperature of 30° C. to prepare toner 6.

TABLE 5

| | | | | | | | | Comparative | Reference |
|---|---|---|---|---|---|---|---|---|---|
| | | | | Example 1 | Example 2 | Example 3 | Example 4 | Example 1 | Example 1 |
| Cooling | Heated resin particle | Temperature | ° C. | 71.0 | 65.2 | 65.2 | 63.5 | 71.0 | 65.2 |
| Condition | dispersion | Transfer flow rate | kg/min | 1.08 | 0.63 | 0.63 | 0.62 | 18 | 0.63 |
| | (before cooling) | Transfer amount | kg | 55.3 | 7.2 | 7.2 | 5.6 | 3.0 | 7.2 |
| | Aqueous medium | Temperature | ° C. | 7.7 | 10.6 | 10.6 | 20.7 | 7.7 | 10.6 |
| | | Transfer flow rate | kg/min | 2.43 | 1.42 | 1.42 | 2.90 | | 1.42 |
| | | Transfer amount | kg | 124.4 | 16.3 | 16.3 | 26.1 | 6.8 | 16.3 |
| | | (or amount) | | | | | | | |
| | Temperature after cooling | | ° C. | 27.2 | 26.3 | 26.3 | 27.4 | 27.0 | 26.3 |
| | Processing time | | — | 51 min | 11.5 min | 11.5 min | 9.0 min | 20 sec | 11.5 min |
| | Transfer flow rate | | kg/min | 3.51 | 2.05 | 2.05 | 3.52 | | 2.05 |
| | Mixing ratio (aqueous medium/heated resin | | — | 2.25 | 2.25 | 2.25 | 4.68 | 2.25 | 2.25 |
| | particle dispersion) | | | | | | | | |
| | Average residence time in static mixer | | sec | 0.30 | 0.50 | 0.50 | 0.30 | | 0.50 |
| | Cooling speed | | ° C./sec | 146 | 78 | 78 | 120 | 2.2 | 78 |
| | Line speed | | m/sec | 0.68 | 0.39 | 0.39 | 0.68 | | 0.39 |
| Drying | Air flow | | m³/min | | | 10 | 10 | | 0.75 |
| Condition | Dryer internal temperature (outlet | | ° C. | 33 | 33 | 37 | 37 | 33 | 30 |
| | temperature) | | | | | | | | |
| Properties | Resin particles | Volume median | μm | 4.9 | 6.3 | 6.3 | 6.3 | 4.9 | 6.3 |
| | | particle diameter D₅₀ | | | | | | | |
| | | CV value | % | 25 | 24 | 24 | 24 | 25 | 24 |
| Evaluation | Low-temperature | Lowest fixing | ° C. | 110 | 110 | 110 | 110 | 115 | — |
| | fixing property | temperature | | | | | | | |

### INDUSTRIAL APPLICABILITY

The resin particles in the resin particle dispersion obtained by the production method of the present invention can be suitably used as a toner for developing an electrostatic charge image excellent in low-temperature fixing property.

1. A method of producing a resin particle dispersion for toner, comprising:
cooling a mixture comprising a resin particle dispersion containing an amorphous resin and a crystalline resin, and an aqueous medium,
wherein the cooling comprises together fluidizing, continuously mixing, and continuously discharging the mixture of the resin particle dispersion and the aqueous medium.

2. The method of producing a resin particle dispersion for toner according to claim 1, wherein the cooling comprises together fluidizing, continuously mixing, and continuously discharging the mixture using a static mixer.

3. The method of producing a resin particle dispersion for toner according to claim 2, wherein an average residence time in the static mixer is 3 seconds or less.

4. The method of producing a resin particle dispersion for toner according to claim 2, wherein an average residence time in the static mixer is 0.1 seconds or more and 2 seconds or less.

5. The method of producing a resin particle dispersion for toner according to claim 1, wherein a cooling rate of the cooling is 20° C./second or more.

6. The method of producing a resin particle dispersion for toner according to claim 1, wherein a cooling rate of the cooling is 30° C./second or more and 300° C./second or less.

7. The method of producing a resin particle dispersion for toner according to claim 1, wherein the cooling cools the resin particle dispersion by 20° C. or more.

8. The method of producing a resin particle dispersion for toner according to claim 1, wherein the cooling cools the resin particle dispersion by 30° C. or more and 80° C. or less.

9. The method of producing a resin particle dispersion for toner according to claim 1, wherein the resin particle dispersion before the cooling has a temperature of [a melting point of the crystalline resin−18° C.] or higher, and the resin particle dispersion after the cooling has a temperature of [the melting point of the crystalline resin−20° C.] or lower.

10. The method of producing a resin particle dispersion for toner according to claim 1, wherein a temperature of the resin particle dispersion before the cooling is [a melting point of the crystalline resin−15° C.] or higher and [the melting point of the crystalline resin+30° C.] or lower.

11. The method of producing a resin particle dispersion for toner according to claim 1, wherein a temperature of the resin particle dispersion after the cooling is [a melting point of the crystalline resin−80° C.] or higher and [the melting point of the crystalline resin−30° C.] or lower.

12. The method of producing a resin particle dispersion for toner according to claim 1, wherein a mixing ratio of the aqueous medium to the resin particle dispersion (aqueous medium/resin particle dispersion) is 1/1 or more and 10/1 or less.

13. The method of producing a resin particle dispersion for toner according to claim 1, wherein the resin particles in the resin particle dispersion before cooling have a mass ratio of the amorphous resin to the crystalline resin [amorphous resin/crystalline resin] of 50/50 or more and 95/5 or less.

14. The method of producing a resin particle dispersion for toner according to claim 1, wherein the resin particle dispersion before the cooling is a dispersion of coalesced particles obtained by aggregating the amorphous resin and the crystalline resin in the aqueous medium to obtain a dispersion of aggregated particles and heat-coalescing the obtained aggregated particles in the aqueous medium to obtain a dispersion of coalesced particles.

15. A method of producing a toner for developing an electrostatic charge image, comprising the method according to claim 1.
